(19) United States
(12) Patent Application Publication
(10) Pub. No.: US 2008/0088453 A1
(43) Pub. Date: Apr. 17, 2008

(54) Radio communication apparatus

(76) Inventors: Yasuhito Kiji, Mishima-shi (JP); Yasuo Matsumoto, Numazu-shi (JP); Kouichi Sano, Ihara-gun (JP); Masakazu Kato, Numazu-shi (JP); Nobuo Murofushi, Susono-shi (JP); Takahiro Shimura, Gotemba-shi (JP)

Correspondence Address: HARNESS, DICKEY & PIERCE, P.L.C., P.O. BOX 828, BLOOMFIELD HILLS, MI, 48303, US

(21) Appl. No.: 11/974,199

(22) Filed: Oct. 11, 2007

(30) Foreign Application Priority Data
Oct. 13, 2006 (JP) 2006-280619
Oct. 18, 2006 (JP) 2006-284057
Oct. 20, 2006 (JP) 2006-286781
Oct. 23, 2006 (JP) 2006-287066

(51) Int. Cl. G08B 13/14

(52) U.S. Cl. 340/572.1

(57) ABSTRACT

A radio communication apparatus sends a signal for assigning a predetermined number of slots to one or more response devices. The response devices individually select one slot, and transmit own specific identification information in that slot. The radio communication apparatus has an all slot number counter and an empty slot number counter. The all slot number counter counts the number of all slots received within a slot counting period. The empty slot number counter counts empty slots among those received within the slot counting period. The radio communication apparatus calculates an estimated number of unread response devices whose identification information is not yet read, from the counted values of each counter and the number of slots at the present time. And, based on the estimated number of unread response devices, the radio communication apparatus determines the number of slots to be assigned next.

### CROSS-REFERENCE TO RELATED APPLICATIONS

This application is based upon and claims the benefit of priority from prior Japanese Patent Applications No. 2006-280619, filed Oct. 13, 2006; No. 2006-284057, filed Oct. 18, 2006; No. 2006-286781, filed Oct. 20, 2006; and No. 2006-287066, filed Oct. 23, 2006, the entire contents of all of which are incorporated herein by reference.

### BACKGROUND OF THE INVENTION

1. Field of the Invention

The present invention relates to a radio communication apparatus for reading identification information specific to response devices existing in a communication area of an antenna, by using radio communication.

2. Description of the Related Art

Recently, a compact response device for radio communication with a radio communication apparatus using radio waves or electromagnetic waves has been developed. A response device can transmit data stored in a memory to a radio communication apparatus, and can write data received from a radio communication apparatus in a memory.

A response device is called a RFID (Radio Frequency Identification), radio tag, IC tag, or electronic tag. A radio communication apparatus is called a tag reader, tag reader and writer, question unit, or base station. A radio communication system comprising such a radio communication apparatus and response devices is widely used in various fields, such as distribution, physical distribution, traffic and security.

A time-slot system is generally used between radio communication apparatus and response devices. A time-slot system is a radio communication system widely used in packet communication, such as a wireless LAN, and is also called an ALOHA system. A time-slot system is adopted in the Generation 2 (GEN. 2) standard, known as the RFID communication standard. Gen. 2 standard is proposed by a RFID standardization organization called Electronic Product Code (EPC) Global.

A radio communication apparatus can receive data from two or more response devices substantially at the same time. This function is realized by a collision avoidance function called anti-collision. An anti-collision in a time-slot system is as follows.

A radio communication apparatus specifies the number of slots in a range of 20-2Q (Q: Fixed value not less than 1) for an response device. When the number of slots is specified, each response device generates a random number within a range of the specified number. For example, when 2 bits (Q=1) are specified as a number of slots, each response device generates any one of 2-bit random numbers “00”, “01”, “10” and “11”. After generating a random number, each response device selects a slot of the number corresponding to that random number, and sends the device's own identification information to a radio communication apparatus by using the slot.

If only one response device selects a certain one slot, a radio communication apparatus can read the identification information of that response device from the selected slot. However, if two or more response devices simultaneously select one slot, a collision occurs. At this time, a radio communication apparatus cannot read the identification information of these response devices.

A radio communication apparatus judges whether an response device whose identification information is not read, that is, a so-called unread response device exists or not. If a collision has occurred, a radio communication apparatus judges that an unread response device exists. In this case, a radio communication apparatus specifies a new number of slots for each response device.

When a new number of slots is specified, an response device which does not complete transmission of its own identification information re-generates a random number within a range of the specified number of slots, and sends its own identification information to a radio communication apparatus by selecting a slot of the slot number corresponding to that random number.

Such a series of communication processes is repeated within a short time between a radio communication apparatus and each response device. Therefore, a radio communication apparatus can read the identification information of each response device substantially simultaneously.

The time required for a radio communication apparatus to read the identification information of all response devices varies according to a correlation between the number of slots assigned to each response device and the number of unread response devices. Thus, a radio communication apparatus is required to calculate an optimum number whenever specifying the number of slots for each response device.

An optimum number of slots can be calculated by probability calculation. For example, Jpn. Pat. Appln. KOKAI Publication No. 11-282975 discloses an example of a method of calculating the number of slots. In this method, the number of unread response devices is assumed from the calculated values of empty slots, successfully-read slots and collision slots, and an optimum number of slots is determined based on the assumed number of unread response devices.

An empty slot is a slot for which no response device transmits identification information. A successfully-read slot is a slot for which only one response device transmits identification information. A collision slot is a slot for which two or more response devices transmit identification information.

After specifying the number of slots for each response device, a radio communication apparatus starts counting the number of these three kinds of slots. After a certain period passes after specifying the number of slots, a radio communication apparatus stops counting the number of slots. Then, a radio communication apparatus obtains a probability density function taking the number of unread response devices as a probability variable.

Then, a radio communication apparatus calculates a probability variable with which a probability density function probability density function becomes maximum, and assumes this variable as an assumed number of unread response devices. After calculating the assumed number of unread response devices, a radio communication apparatus determines a new number of slots based on this assumed number, and specifies the new number of slots for each response device. Then, a radio communication apparatus resumes counting the number of slots.

As describe above, a conventional radio communication apparatus counts the numbers of empty slots, successfully-read slots and collision slots. From the numbers of these slots, a conventional communication apparatus obtains a probability density function probability density function taking the number of unread response devices as a probability variable, calculates a probability variable with which the probability density function probability density function becomes maximum, and assumes the calculated probability variable to be an estimated number of unread response devices. Thus, there is a problem that the load of a radio communication apparatus is increased.

### BRIEF SUMMARY OF THE INVENTION

It is an object of the invention to reduce the load of a radio communication apparatus.

According to an aspect of the invention, there is provided radio communication apparatus comprising: a sending means for sending a signal for assigning a predetermined number of slots from an antenna to one or more response devices; a reading means for reading identification information of one or more response devices among response devices receiving the signal, by using a radio communication system in which an response device whose identification information is not yet read, a so-called unread response device, individually selects one slot, and transmits own specific identification information in that slot; an all slot number counter for counting the number of all slots that are within a slot counting period in a predetermined period after the signal is sent; an empty slot number counter for counting the number of empty slots whose identification information is not transmitted by an response device, among all slots that are within the slot counting period; an estimated number calculation means for calculating an estimated number of the unread response devices based on the counted values of the all slot number counter and empty slot number counter, and the number of slots assigned by the signal, at the time when the predetermined period has passed; and a deciding means for deciding the number of slots assigned by the signal to be sent next, based on the estimated number of unread response devices.

According to another aspect of the invention, there is provided a radio communication apparatus comprising: a sending means for sending a signal for assigning a predetermined number of slots from an antenna to one or more response devices; a reading means for reading identification information of one or more response devices among response devices receiving the signal, by using a radio communication system in which an response device whose identification information is not yet read, a so-called unread response device, individually selects one slot, and transmits own specific identification information in that slot; a successfully-read slot number counter for counting the number of successfully-read slots for which only one response device transmits identification information, among slots that are within a slot counting period in a predetermined period after the signal is sent; an expected value calculation means for calculating an expected value when the number of response devices existing in the communication area of the antenna is more than the calculated value of the successfully-read slot number counter; an estimated number calculation means for calculating an estimated number of the unread response devices at the time when the predetermined period has passed, as a value obtained by subtracting the counted value of the successfully-read slot number counter from the expected value; and a deciding means for deciding the number of slots assigned by the signal to be sent next, based on the estimated number of unread response devices.

According to a further aspect of the invention, there is provided a radio communication apparatus comprising: a sending means for sending a signal for assigning a predetermined number of slots from an antenna to one or more response devices; a reading means for reading identification information of one or more response devices among response devices receiving the signal, by using a radio communication system in which an response device whose identification information is not yet read, a so-called unread response device individually selects one slot, and transmits own specific identification information in that slot; a correlation data memory which stores data indicating a correlation between the number of unread response devices and the number of slots with which the probability that one unread response device sends the identification information in one slot becomes highest, when the number of unread response devices exist in the communication area of the antenna; and a retrieving means for searching the correlation data memory by an actual number of the unread response devices at the time before the signal is sent, and reading the number of slots corresponding to the actual number from the correlation data memory, wherein the number of slots to store the correlation data memory is within the range of the number of slots assignable by the signal, and the sending means sends a signal for assigning the number of slots read from the correlation data memory.

According to a further aspect of the invention, there is provided a radio communication apparatus comprising: a sending means for sending a signal for assigning a predetermined number of slots from an antenna to one or more response devices; a reading means for reading identification information of one or more response devices among response devices receiving the signal, by using a radio communication system in which an response device whose identification information is not yet read, a so-called unread response device individually selects one slot, and transmits own specific identification information in that slot; a correlation data memory which stores data indicating a correlation between the number of unread response devices and the number of slots with which the probability that one unread response device sends the identification information in one slot becomes highest, when the number of unread response devices exist in the communication area of the antenna; a judging means for judging whether the number of unread response devices at the time before the signal is sent is less than a set value; a variable mode control means for reading the number corresponding to the number of unread response devices from the correlation data memory at the time when the number of unread response devices is judged larger than the set value, and controlling the sending means to send a signal for assigning the number of slots; and a fixed mode control means for controlling the sending means to send a signal for assigning a predetermined number of slots, when the number of unread units is judged less than the set value; wherein the number of slots stored in the correlation data memory is within a range of the number of slots assignable by the signal.

According to a still another aspect of the present invention, there is provided a radio communication apparatus comprising: a sending means for sending a signal for assigning a predetermined number of slots from an antenna to one or more response devices; a reading means for reading identification information of one or more response devices among response devices receiving the signal, by using a radio communication system in which an response device whose identification information is not yet read, a so-called unread response device individually selects one slot, and transmits own specific identification information in that slot; a fixed mode correlation data memory which stores a correlation between the number of unread response devices and a first number of slots, when the number of slots necessary for reading identification information of all unread response devices when the number of slots assigned to the response devices is fixed to a first number of slots, and the number of slots necessary for reading identification information of all unread response devices when the number of slots assigned to the response devices is fixed to a second number of slots large next to the first number of slots, become equal to each other; and a retrieving means for searching the fixed mode correlation data memory by the number of unread response devices at the time before the signal is sent, and reading the number of slots corresponding to the number of unread response devices from the fixed mode correlation data memory, wherein the number of slots stored in the fixed mode correlation data memory is within a range of the number of slots assignable by the signal, and the sending means repeatedly sends a signal for assigning the number of slots read from the correlation data memory.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an embodiment of a radio communication system according to the present invention;

FIG. 2 is a timing chart showing examples of signals transmitted/received between a radio communication apparatus and two or more response devices in the radio communication system of FIG. 1;

FIG. 3 is a graph showing a correlation between the number of unread response devices t and probability P1 (8, t) in the radio communication system of FIG. 1;

FIG. 4 is a graph showing a correlation among the number of unread response devices t and probability P1 (2, t), probability P1 (4, t) and probability P1 (8, t) in the radio communication system of FIG. 1;

FIG. 5 is a view showing a data structure of a correlation data memory included in a radio communication apparatus in a first embodiment;

FIG. 6 is a view showing a main memory area formed in a storage unit of a radio communication apparatus in a first embodiment;

FIG. 7 is a flowchart showing a main control procedure executed by a control unit of a radio communication apparatus in a first embodiment;

FIG. 8 is a graph showing an example of a probability density function taking the number of response devices existing in a communication area of an antenna as a probability variable, in the radio communication system of FIG. 1;

FIG. 9 is a graph showing the case that a range of the number of response devices “0” to the number of successfully-read number “Tr” is removed from the graph of FIG. 8;

FIG. 10 is a block diagram of a radio communication system in a second embodiment;

FIG. 11 is a view showing a data structure of a correlation data memory possessed by a radio communication apparatus in a second embodiment;

FIG. 12 is a view showing a main memory area formed in a storage unit of a radio communication apparatus in a second embodiment;

FIG. 13 is a flowchart showing a main control procedure executed by a control unit of a radio communication apparatus in a second embodiment;

FIG. 14 is a view showing a histogram concerning a concrete example of a second embodiment;

FIG. 15 is a table showing a relative frequency distribution obtainable from the histogram of FIG. 14;

FIG. 16 is a view showing a main memory area formed in a storage unit of a radio communication apparatus in a third embodiment;

FIG. 17 is a flowchart showing a main control procedure executed by a control unit of a radio communication apparatus in a third embodiment;

FIG. 18 is a block diagram of a radio communication system in a fourth embodiment;

FIG. 19 is a graph showing a relationship between the throughput of each number of slots and the number of unread response devices in a fourth embodiment;

FIG. 20 is a view showing a data structure of a fixed mode correlation data memory possessed by a radio communication apparatus in a fourth embodiment;

FIG. 21 is a view showing a main memory area formed in a storage unit of a radio communication apparatus in a fourth embodiment;

FIG. 22 is a flowchart showing a main operation procedure of a control unit when a first trigger switch is turned on, in a fourth embodiment;

FIG. 23 is a flowchart showing other operation procedures of a control unit when a first trigger switch is turned on, in a fourth embodiment; and

FIG. 24 is a flowchart showing a main operation procedure of a control unit when a second trigger switch is turned on, in a fourth embodiment.

### DETAILED DESCRIPTION OF THE INVENTION

Hereinafter, embodiments of the present invention will be explained with reference to the accompanying drawings. Each embodiment shows an example that the present invention is applied to a radio communication apparatus for reading specific identification information from two or more response devices in a noncontact manner by using a radio communication system called a time-slot system.

### EMBODIMENT 1

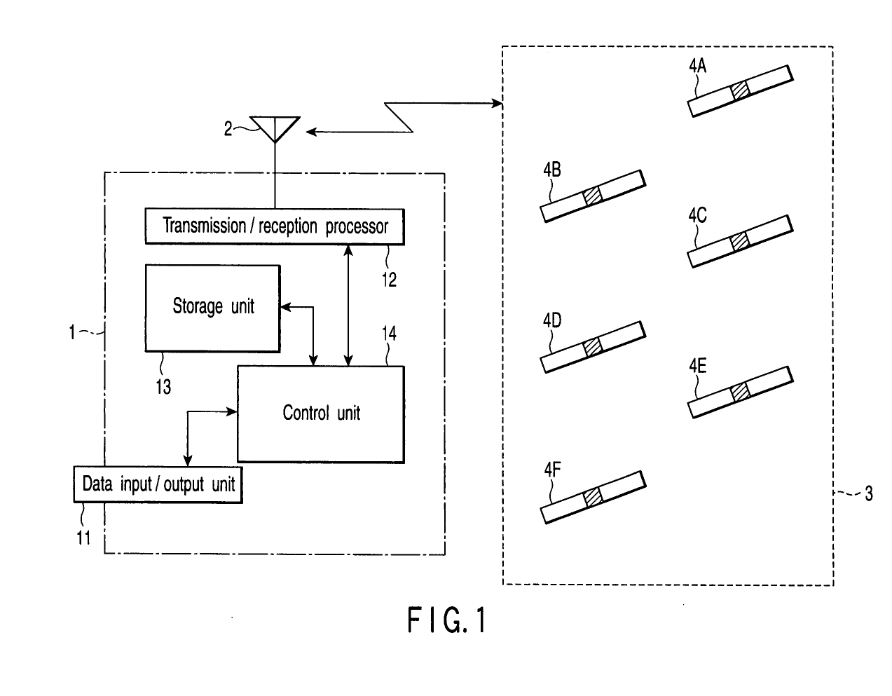

FIG. 1 is a basic block diagram of a radio communication system according to a first embodiment. This system consists of a radio communication apparatus 1 having an antenna 2, and response devices (six in the drawing) 4A-4F existing in a communication area 3 of the antenna 2. The radio communication apparatus 1 comprises a data input/output unit 11, a transmission/reception processor 12, a storage unit 13, and a control unit 14.

An external unit (not shown) is connected to the data input/output unit 11 via a communication cable. The data input/output unit 11 receives data from an external unit, and sends the received data to the control unit 14. The data input/output unit 11 receives transmission data from the control unit 14, and sends the data to an external unit.

The transmission/reception processor 12 is connected with the antenna 2. The transmission/reception processor 12 receives a transmission signal from the control unit 14, modulates the received signal, and gives the modulated signal to the antenna 2. The antenna 2 radiates the modulated signal as a radio wave. The transmission/reception processor 12 takes in the radio wave received by the antenna 2, demodulates the wave signal, and gives the demodulated signal to the control unit 14. Also transmission/reception processor 12 includes sending means.

The storage unit 13 has a nonvolatile rewritable memory area. The control unit 14 controls the data input/output unit 11, transmission/reception processor 12 and storage unit 13.

The radio communication apparatus 1 performs anti-collision with the response devices 4A-4F by a time-slot system, and reads specific identification information possessed by the response devices 4A-4F in a non-contact manner.

First, the radio communication apparatus 1 sends a signal for specifying the number of slots in a range of 2^{O}-2^{Q} for each response device 4, from the antenna 2. When the number of slots is specified, the response device 4 whose identification information is not yet read among the response devices, that is, a so-called unread response device generates a random number within a range of the specified number of slots. The unread response device selects the slot of the slot number corresponding to that random number, and sends its identification information to the radio communication apparatus by using this slot.

At this time, if a certain one slot is selected by only one unread response device, the radio communication apparatus 1 can read the identification information of that response device from that slot. The slot of this time is called a successfully-read slot.

On the contrary, if a certain one slot is selected by two or more unread response devices, a transmission signal of that slot is disturbed. Thus, the radio communication apparatus 1 cannot read the identification information of these response devices. The slot of this time is called a collision slot.

There is a case that a certain slot is selected by no unread response device. The slot of this time is called an empty slot.

The radio communication apparatus 1 identifies a slot other than a successfully-read slot by a wave intensity when receiving a slot. Namely, when receiving a slot with a wave intensity exceeding a predetermined threshold value and difficult to read identification information, the radio communication apparatus regards that slot as a collision slot. Contrarily, when receiving a slot with a wave intensity lower than a predetermined threshold value and difficult to read identification information, the radio communication apparatus regards that slot as an empty slot.

After reading identification information from the response device 4, the radio communication apparatus 1 sends a signal indicating the success of reading the identification information, from the antenna 2. This signal is received by the response device 4 which stores the same identification information. Receiving this signal, the response device 4 will not send identification information thereafter.

The radio communication apparatus 1 sends a control signal including the identification information read from the response device 4, if necessary. This signal is received by the response device 4 which stores the same identification information. The response device 4 receiving this signal ensures a link with the radio communication apparatus 1. As a result, the radio communication apparatus 1 can read other information possessed by this response device 4 in a non-contact manner. The radio communication apparatus 1 also permits writing of optional information in a non-contact manner.

Incidentally, the Gen. 2 standard as one of the RFID communication standards uses 16-bit random numbers in the identification information of the response device 4 when performing anti-collision. The 16-bit random numbers are changed whenever the response device 4 sends identification information, that is, disposable identification information used only once. In the Gen. 2 standard, when receiving information indicating the success of reading disposable identification information from the radio communication apparatus 1, the response device 4 sends the radio communication apparatus 1 the identification information specific to that response device.

Generally, identification information specific to an response device is about 10 times larger than 16 bits. Thus, in the Gen. 2 standard, disposable identification information different from identification information specific to an response device is used for anti-collision. Since the amount of disposable identification information is lower, the time required for anti-collision can be reduced.

In this embodiment, identification information denotes the above-mentioned identification information used for anti-collision. However, for simplification of explanation, the identification information for anti-collision is described as being the same as the identification information specific to an response device.

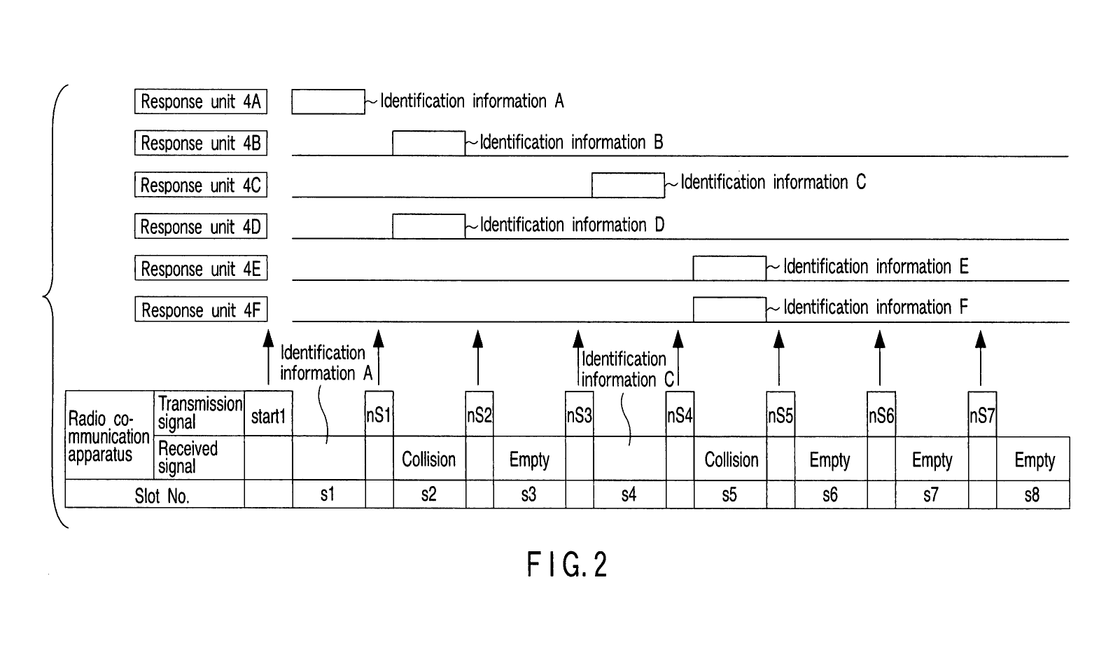

FIG. 2 is a timing chart showing examples of signals transmitted/received between the radio communication apparatus 1 and six response devices 4A-4F for anti-collision. In FIG. 2, only one cycle is shown, and the time passes from the left to right.

The radio communication apparatus 1 first specifies the number of slots for the response devices 4A-4F by a cycle start signal start.1. The examples of FIG. 2 show the case that the number of slot “8” is specified. The response devices 4A-4F select one of eight slots Nos. s1-s8, and send own identification information to the radio communication apparatus 1.

In the examples of FIG. 2, only the response device 4A selects the slot No. s1, and sends its identification information. Similarly, only the response device 4C selects the slot No. s4, and sends its identification information. Therefore, these slots are successfully-read slots. The radio communication apparatus 1 can read the identification information A and C of the response devices 4A and 4C.

After reading the identification information A of the response device 4A from the slot No. s1, the radio communication apparatus 1 includes this identification information A in the slot start signal nS1 to be sent next. After reading the identification information C of the response device 4C from the slot No. s4, the radio communication apparatus 1 includes this identification information C in the slot start signal nS4 to be sent next. As a result, these response devices 4A and 4C will not send their identification information in subsequent cycles. As explained above, the response device 4 whose identification information is read by the radio communication apparatus 1, and which will not send its identification information in subsequent cycles, is called an already-read response device.

In the examples of FIG. 2, the response devices 4B and 4D simultaneously select the slot No. S2 and send their identification information. Similarly, the response devices 4E and 4F simultaneously select the slot No. s5 and send their identification information. Therefore, these slots are collision slots. The radio communication apparatus 1 cannot read the identification information of these response devices 4B, 4D, 4E and 4F. There is no response device that selects the residual slots Nos. s3, 36, s7 and s8. Therefore, these slots are empty slots.

Therefore, the identification information of the response devices 4B, 4D, 4E and 4F are not included in the slot start signals nS1-nS7. As a result, these response devices 4B, 4D, 4E and 4F try to send their own identification information by using one of the specified number of slots in the next cycle. As explained above, the response device 4 whose identification information is not read by the radio communication apparatus 1, and which will send its identification information in the next cycle, is called an unread response device.

The radio communication apparatus 1 judges whether an unread response device exists or not from the signals received from all slots in one cycle. For example, if there is a collision slot in one cycle, even if this is only one slot, the radio communication apparatus 1 judges that an unread response device exists. If all time slots in one cycle are empty slots, the radio communication apparatus 1 judges that an unread response device does not exist.

The radio communication apparatus 1 determines the new number of slots each time one cycle is completed. The radio communication apparatus 1 specifies the new number of slots for each response device 4 by the next cycle start signal start.n (n: the number of sending a cycle start signal). The radio communication apparatus 1 finishes the reading operation when judging that an unread response device is not found successively in a predetermined number k (k>1).

The new number of slots is conventionally determined by a probability calculation method. The probability calculation method for determining the number of slots will be explained.

First, consider a probability that there is one response device 4 to send identification information to one slot. When there is one response device 4 to send identification information to one slot, the radio communication apparatus 1 can read the identification information of this response device 4. Therefore, this probability is equivalent to a probability that the radio communication apparatus 1 can read the identification information of the response device 4 in one slot.

Taking the number of slots specified by the radio communication apparatus 1 for the response device 4 as a symbol S, and the number of unread response devices in the response device 4 existing in the communication area of the antenna 2 as a symbol t, a probability P1 (S, t) of the capability of reading identification information is expressed by the following formula (1)

$$P 1 ( S , t ) = \frac{t}{S} \times {( 1 \frac{1}{S} )}^{t - 1} \qquad ( 1 )$$

The formula (1) assumes a probability of sending identification information from one unread response device to a certain slot to be 1/S, and a probability of not sending identification information from other unread response devices (t−1) to be (1-1/S) (t−1), and adds up these probabilities and the number of unread response devices t. The symbol “ˆ” of the probability (1−1/S) ˆ(t−1) indicates a power.

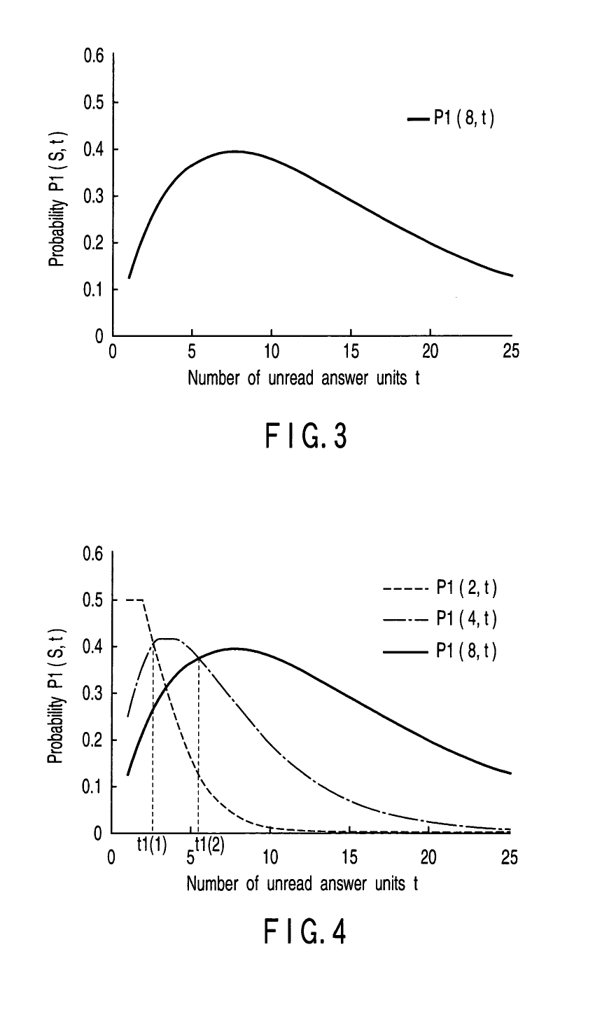

When S=8 in the formula (1), that is, when the probability P1 (8, t) is shown as a graph, it is as shown in FIG. 3. In this graph, the horizontal axis represents the number of unread response devices t, and the vertical axis represents the probability P1 (8, t) for that number t.

Here, the number t of unread response devices is “0” or an integer equal or to larger than “1”. In this case, the probability P1 (S, t) becomes a maximum when the number of slots S is equal to the number of unread response devices t. Therefore, by always setting the number of slots S assigned by the radio communication apparatus 1 to the response device 4 to be the same as the number of unread response devices t, the time required for the radio communication apparatus 1 to read the identification information of all response devices 4 can be reduced to the minimum.

However, the number of slots S selectable by the radio communication apparatus 1 is a discrete value due to restrictions in mounting. For example, in the above-described Gen. 2 standard, the number of slots S selectable by the radio communication apparatus 1 is available from 16 kinds, from 0^{th} to the 15^{th} power of 2. Namely, the number of slots S is a power of 2, and a discrete number 1, 2, 4, 8, 16, 32, 64, . . . . Thus, it is difficult to set the number of slots S to be always the same as the number of unread response devices t.

The number of slots when there are n kinds of the number of slots S selectable by the radio communication apparatus 1 is expressed by S(i){i=1, 2, . . . , n}. The number of slots S(i) and the number of slots S(i+1) are in the relation of S(i)<S(i+1).

When the number of unread response devices t is a value between the numbers of slots S(i) and S(i+1), the probabilities P1(S(i), t) and P1(S(i+1), t) are calculated. The probability P1(S(i), t) is a probability that when the number of slots S(i) is specified, the number of response devices 4 to transmit identification information to one slot is 1. The probability P1(S(i+1), t) is a probability that when the number of slots S(i+1) is specified, the number of response devices 4 to transmit identification information to one slot is 1.

The probabilities P1(S(i), t) and P1(S(i+1), t) are compared, and the number of slots S(i) or S(i+1) with a higher probability is selected. The selected number of slots is then assigned to the response devices 4. As a result, it becomes possible to increase the probability that the radio communication apparatus 1 will read the identification information of a number of unread response devices, t, in one cycle.

Assume that the number of slots selectable by the radio communication apparatus 1 is three, S(1)=2, S(2)=4 and S(3)=8. The relation of the probabilities P1(2, t), P1(4, t) and P1(8, t) to the number of unread apparatus t at this time is shown in the graph of FIG. 4.

In FIG. 4, assume that the number of unread response devices t with which the probabilities P1(2, t) and P1(4, t) are equal is t1(1). Assume that the number of unread response devices t with which the probabilities P1(4, t) and P1(8, t) are equal is t1(2).

As seen from FIG. 4, when the number of unread response devices t is smaller than the value t1(1), the number of slots S is set to “2”. When the number of unread response devices t is not less than t1(1) and less than the value t1(2), the number of slots S is set to “4”. When the number of reread response devices t is higher than the value t1(2), the number of slots S is set to “8”. By determining the number of slots as above, the probability that the response device 4 to send identification information to one slot is 1, or the probability P1(S, t) to obtain identification information of an unread response device becomes highest.

As described above, the value of unread response devices with which the probabilities P1(S(i), t) and P1(S(i+1), t) become equal is a point of changing the number of slots. Next, an explanation will be given of a method of calculating the value of unread response devices with which the probabilities P1(S(i), t) and P1(S(i+1), t) become equal.

The value of unread response device with which the probabilities P1(S(i), t) and P1(S(i+1), t) become equal is expressed as t1(i){i=1, 2, . . . , n}. The probability P1(S(i), t) is a probability that the number of response devices 4 to send identification information to one slot is 1 when the slot of the number of slots S(i) is specified. The probability P1(S(i+1), t) is a probability that the number of response devices 4 to send identification information to one slot is 1 when the slot of the number of slots S(i+1) is specified. The number of slots S(i+1) is a number that is large next to the number of slots S(i) among the number of slots selectable by the radio communication apparatus 1.

The value t1(i){i=1, 2, . . . , n} of unread response devices is calculated by the mathematical expression (2). In the formula (2), the symbol “ln” indicates a natural logarithm.

$$t 1 ( i ) = 1 + \frac{ln S ( i ) - ln S ( i + 1 )}{ln \{ S ( i + 1 ) ( S ( i ) - 1 ) \} - ln \{ S ( i ) ( S ( i + 1 ) - 1 ) \} } \qquad ( 2 )$$

Therefore, the number of unread response devices t with the value t1(i){i=1, 2, . . . , n} is compared, and a minimum value min[t1(i)] not less than the number t is obtained. The smaller one of the number of slots S(i) and S(i+1) is determined taking this minimum value min[t1(i)] as a new number of slots S. As a result, it becomes possible to increase the probability P1(S, t) of obtaining identification information of the unread response device to highest.

In the first embodiment, the number of unread response devices t1(i){i=1, 2, . . . , n} is calculated by using the formula (2), for each kind of the assignable number of slots S(i){i=1, 2, . . . , n}. And, a correlation data memory 15 set by correlating the integer portion T1(i) of these unread response devices t1(i) with the number of slots S(i) is created. The value t1(n) is infinite. The value t1(i) may be rounded by omitting/raising decimals or by rounding off a fractional portion.

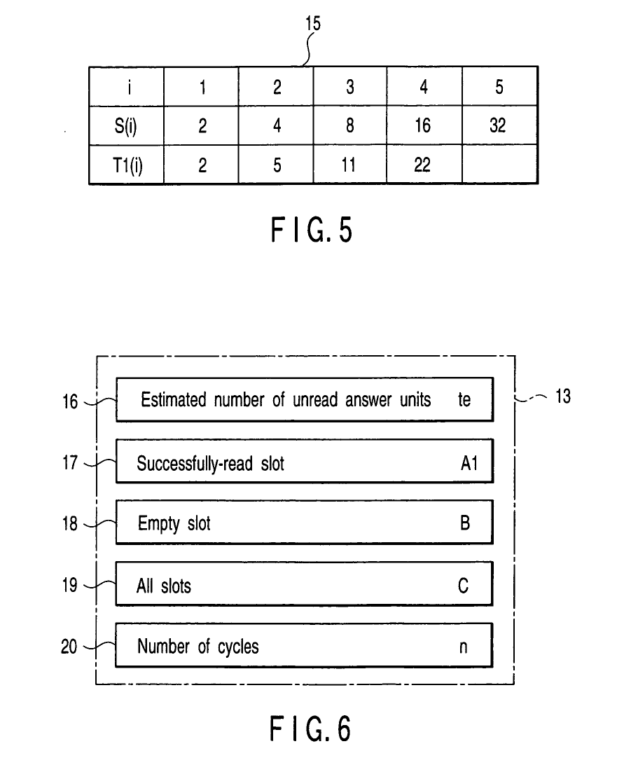

In the example of FIG. 5, there are five kinds of assignable number of slots S(i), namely, S(1)=2, S(2)=4, S(3)=8, S(4)=16 and S(5)=32. In this case, when calculating the number of unread response devices t1(1) with which the probability P1(S, t) becomes equal to the numbers of slots S(1) and S(2) by using the formula (2), the integer portion T1(1) of the number becomes “2”. Likewise, the integer portion T1(2) of the number where the probability P1(S, t) becomes equal to the numbers of slots S(2) and S(3) becomes “5”. The integer portion T1(3) of the number with which the probability P1(S, t) becomes equal to the numbers of slots S(3) and S(4) becomes “11”. The integer portion T1(4) of the number where the probability P1(S, t) becomes equal to the numbers of slots S(4) and S(5) becomes “22”.

The calculation of the formula (2) is performed by an external unit of the radio communication apparatus 1, and the result is written in the correlation data memory 15. This releases the radio communication apparatus 1 from the load of calculation.

The formula (1) expresses a binomial distribution taking “1” as a variate. On the other hand, it is known that a binomial distribution taking a variate X can be approximated by Poisson distribution taking a probability variable X. Therefore, the value t1(i) is expressed by the following formula (3) when approximating the formula (1) as Poisson distribution.

$$t 1 ( i ) = \frac{S ( i ) \{ ln S ( i + 1 ) - ln S ( i ) \}}{1 - \frac{S ( i )}{S ( i + 1 )}} \qquad ( 3 )$$

Further, when the number of slots S(i) is an equal ratio sequence consisting of an initial item a and an equal ratio r, the formula (3) becomes the following formula (4).

$$t 1 ( i ) = \frac{a \times {r}^{i - 1} \times ln r}{1 - \frac{1}{r}} \qquad ( 4 )$$

The formulas (3) and (4) are small in load required for calculation compared with the formula (2). Therefore, the formula (3) or (3) may be used instead of the formula (2) for calculating the value t1(i){I=1, 2, . . . , n} of unread response devices.

However, the number of slots S(i) selectable by the radio communication apparatus 1 is only when i=1, 2, . . . , n. Therefore, when i=n, S(i+1) of the formula (2) is not defined, and the value t1(n) is not calculated. Therefore, the value t1(n) is infinity. The value t1(n) is also infinity in the formulas (3) and (4), which are approximate expressions of the formula (2).

In the explanation hereinbefore, it is assumed that the radio communication apparatus 1 previously has the information about the number of the response devices 4 existing within the communication area 3 of the antenna 2. If the radio communication apparatus 1 previously has the information about the number, it is possible to calculate the number of residual unread response devices t by subtracting the number of successfully-read slots from that number.

However, it is sometimes difficult for the radio communication apparatus 1 to previously have the information about the number of the response devices 4. For example, when reading the identification information of the response device 4 for counting the number of the response devices 4 existing in the communication area 3. In such a case, it is necessary to estimate the number of unread response devices 5 by any method, compare the estimated value with the value t1(1), and determined a new number of slots S.

Next, a method of estimating the number of unread response devices t will be explained. First, a conventional method will be explained. The conventional method comprises a step of counting a successfully-read slot, empty slot and collision slot within a predetermined slot-counting period, a step of counting the number of all slots within that period, a step of calculating a probability density function taking these number of slots as a probability variable, and a step of deciding a value with which the probability density function becomes a maximum to be an estimated value te of an unread response device.

However, when assuming the number of successfully-read slot to be A, the number of empty slots to be B, the number of all slots within the slot-counting period to be C, and the number of collision slots to be D, the number of collision slots D can be obtained by (C−A−B). Likewise, the number of empty slots B can be obtained by (C−A−D). The number of all slots C can be obtained by (A+B+D). Therefore, it is possible to omit a step of counting the number of one of four slots. In the following explanation, the step of counting collision slots D will be omitted.

As described hereinbefore, an occurrence ratio of successfully-read slots is equivalent to the probability that the number of response devices 4 to send identification information to one time slot is 1.

Therefore, the occurrence ratio of successfully-read slots can be indicated by the probability P1(S, t) in the formula (1). According to this, an occurrence ratio of empty slots is indicated by the probability P0(S, t) in the following formula (5).

$$P 0 ( S , t ) = {( 1 - \frac{1}{S} )}^{t} \qquad ( 5 )$$

An occurrence ratio of collision slots is indicated by the probability Pc(S, t) in the following formula (6), because the number of collision slots D is obtained by subtracting the numbers of successfully-read slots A and empty slots in a slot-counting period from the number of all slots C in the slot-counting period.
Pc(S,t)=1−P0(S,t)−P1(S,t) (6)

Therefore, a probability density function f (A, B, C) taking the numbers A, B and C of successfully-read slots, empty slots B and all slots C as probability variables, can be expressed by the following formula (7) when expressing as a polynomial distribution taking the numbers of slots A, B and C as variables.

$$f ( A , B , C ) = \frac{C !}{A ! B ! ( C - A - B ) !} P 1 {( S , t )}^{A} \times P 0 {( S , t )}^{B} \times {Pc ( S , t )}^{( C - A - B )} \qquad ( 7 )$$

Here, the number of slots S is a value to be bet by the radio communication apparatus 1, and the number of slots A, B and C are values countable by the radio communication apparatus 1. Contrarily, the number of unread response devices t is an unknown number. Therefore, the formula (7) can be expressed as follow the formula (8) as a function taking the number of unread response devices t as a variable.
ft(t)=f(A,B,C) (8)

The value of t to maximize the solution ft(t) of this formula (8) becomes a maximum likelihood estimate te of the value t. Therefore, after the formula (8) is set up, the maximum likelihood estimate te is calculated. But, the maximum likelihood estimate te is an estimated value of unread response devices immediately before start of counting each slot.

On the other hand, when the radio communication apparatus 1 specifies the number of slots S for each of the response devices 4 by the start.n, then the number of unread response devices will be decreased by the number of slots A. Therefore, the estimated value of unread response devices becomes (te−A) at the time of determining the next number of slots A.

Therefore, the radio communication apparatus 1 compares the estimated value (te−A) of unread response devices with the value of t1(i){i=1, 2, . . . , n}, obtains a minimum value min[t1(i)] that is not less than the estimated value (te−A), and determines the number of slots (i) taking this minimum value min[t1(i)], which is smaller than the number of slots S(i+1), as a new number of slots S.

In the above conventional method of estimation, a particularly large calculation load is applied when calculating the maximum likelihood estimate te of t after setting up the formula (8). The estimated value (te−A) is a value of unread response device at the time when the period of counting the numbers of slots A and B. Thus, if it takes much time to calculate the maximum likelihood estimate te, a successfully-read slot may occur even during calculation of the maximum likelihood estimate te.

Therefore, the radio communication apparatus 1 counts also the number of successfully-read slots A2 occurred during calculation of the maximum likelihood estimate te. Immediately after calculating the maximum likelihood estimate te, the estimated value (te−A−A2) of unread response devices is compared with the value of t1(i){i=1, 2, . . . , n}. And, the minimum value min[t1(i)] by the value t1(i) equal to or not less than the estimated value (te−A−A2) is obtained. The number of slots S(i) is then determined by taking this minimum value min[t1(i)], which is smaller than the number of slots S(i+1), as a new number of slots S.

As the number of all slots C in each slot counting period is larger, the value A/C comes close to the occurrence ratio of successfully-read slots. Likewise, the value B/C comes close to the occurrence ratio of empty slots. The value A/C is a value obtained by dividing the number A of successfully-read slots by the number C of all slots in a slot counting period. The value B/C is a value obtained by dividing the number B of empty slots by the number C of all slots.

The functions of probability density f (A, B, C) in the formula (7) or (8) take the numbers of slots A, B and C as a probability variable. As the slot counting period becomes longer, the number of slots C becomes higher. Therefore, the accuracy of the probability density function f (A, B, C) is increased by setting the slot counting period longer. And, the precision of the estimated value te is also increased.

On the other hand, the time required to estimate the number of unread response devices becomes the total of the time to count the slots A/B/C and the time to calculate the estimated value te, by considering from the time to start counting the slots A, B and C. As this total time is shorter, the radio communication apparatus 1 can quickly adapt to changes in the number of unread response devices. Namely, the efficiency of reading the identification information of the response device 4 is increased.

Therefore, the first embodiment proposes a calculation method to reduce the time to calculate the estimated value te. Concretely, the formula (8) is simplified. When the calculation time is reduced, the time required to estimate the number of unread response devices is reduced. As a result, the efficiency of reading the identification information of the response device 4 is increased.

In the first embodiment, the function f (B, C) of probability density is calculated taking the number B of empty slots and the number C of all slots as probability variables. This function f (B, C) of probability density is expressed by the following formula (9) when expressing it as a binomial distribution obtainable from the slot numbers B and C.

$$f ( B , C ) = \frac{C !}{B ! ( C - B ) !} P 0 {( S , t )}^{B} \times {\{ 1 - P 0 ( S , t ) \}}^{( C - B )} \qquad ( 9 )$$

This formula (9) expresses a binomial distribution of the probability variable B in C times of independent attempts. Therefore, an expected value m of the probability variable B can be expressed by the following formula (10).
m=C×P0(S,t) (10)

In the formula (9), the numbers of slots B and C are handled as variables. These numbers of slots B and C can be counted by the radio communication apparatus 1 as described before. The number of slots S is a value to be set by the radio communication apparatus 1.

An argument t of a function P0(S, t) with which a solution m of the formula (10) becomes the same value as the number of slots B becomes the estimated value te of unread response devices at the time to start counting the number of empty slots B. Therefore, by substituting the numbers of slots B and C, the probability P0(S, t) of the formula (5), and the number of slots S set by the radio communication apparatus 1 into the formula (10), the estimated value te of unread response devices is obtained. In this case, the estimated value te can be easily obtained by the following formula (11).

$$te = \frac{ln B - ln C}{ln ( S - 1 ) - ln S} \qquad ( 11 )$$

The value S of the formula (11) is the number of slots specified by the radio communication apparatus 1 immediately before start of counting the number of empty slots B. The solution te concluded by the formula (11) is an estimated value of unread response devices at the same timing.

Assume the number of identification information of the response devices read by the radio communication apparatus 1 within the period from the start of counting the number of empty slots B to decision of the next number of slots S, or the number of successfully-read slots, to be A1. Then, the estimated value of unread response devices at the timing of determining the new number of slots S becomes (te−A1).

Therefore, when determining a new number of slots, the radio communication apparatus 1 compares the estimated value (te−A1) of unread response devices with the value t1(i){i=1, 2, . . . , n}, and obtains the minimum value min[t1(i) by a value not less than the estimated value (te−A1). The number of slots S(i) is then determined by taking this minimum value min[t1(i)], which is smaller than the number of slots S(i+1), as a new number of slots S.

In the first embodiment, the correlation data memory 15 is stored in the storage unit 13 of the radio communication apparatus 1. As shown in FIG. 6, the storage unit 13 includes an estimated number memory 16 of unread response devices, a counter 17 of the number of successfully-read slots A1, a counter 18 of the number of empty slots, a counter 19 of the number of all slots C, and a counter 20 of the number of cycles n.

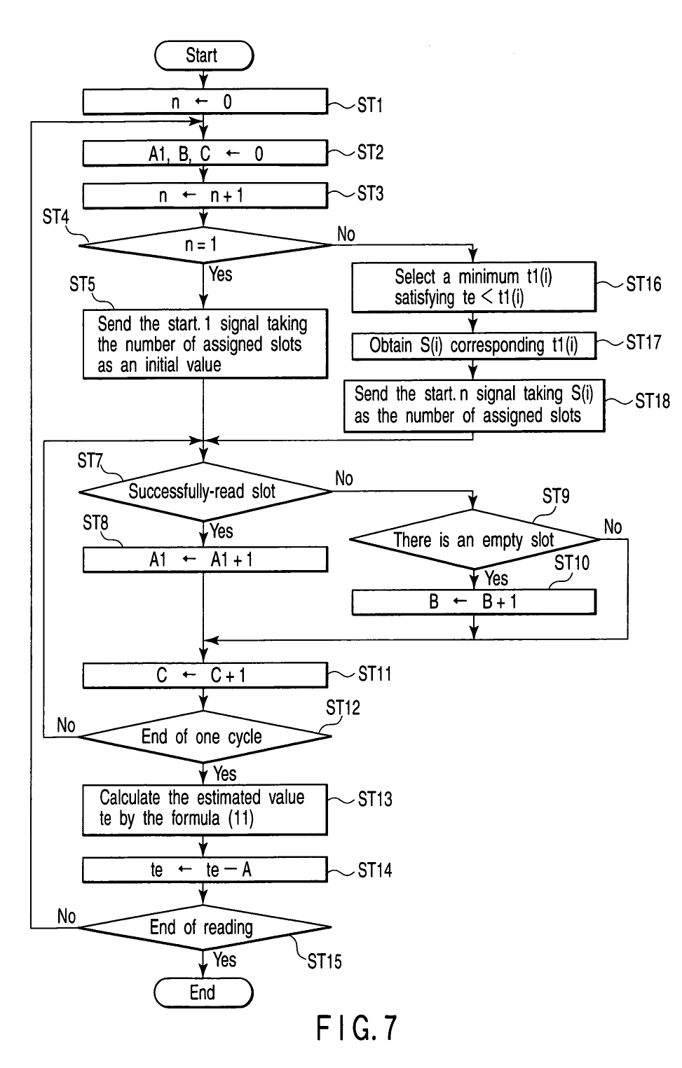

The control unit 14 of the radio communication apparatus 1 executes reading identification information of the response device 4 existing in the communication area of the antenna 2, according to the procedure shown in the flowchart of FIG. 7.

First, the control unit 14 resets a counted value n of a cycle number counter 20, as ST (step) 1. Then, the control unit 14 resets counted values A1, B and C of the successfully-read slot number counter 17, empty slot number counter 18 and all slot number counter 19 to zero, as ST2.

Then, the control unit 14 increments the counted value of the cycle number counter 20 by “1”, as ST3. Then, the control unit 14 judges whether the counted value n of the cycle number counter 20 is “1” or other, as ST4.

When the counted value n is “1”, the control unit 14 starts a first cycle of a time-slot system. Namely, the control 14 sends a cycle start signal start.1 to the transmission/reception processor 12, as ST5. In this time, the number of slot S assigned to each response device 4 by the cycle start signal start.1 shall be a preset initial value.

Then, the control unit 14 judges whether a received slot is a successfully-read slot or not, as ST7. When the received slot is a successfully-read slot, the control unit 14 counts up the counted value A1 of the successfully-read slot number counter 17 by “1”. At the same time, the control unit 14 counts up the counted value C of the all slot number counter 19 by “1”, as ST11.

When the received slot is not a successfully-read slot, the control unit 14 judges whether the received slot is an empty slot or not, as ST9. When the received slot is an empty slot, the control unit 14 increments the counted value B of the empty slot number counter 18 by “1”, as ST10. The control unit 14 also increments the all slot number counter 19 by “1”, as ST11.

When the received slot is neither a successfully-read slot nor an empty slot, the control unit 14 increments only the all slot number counter 19 by “1”, as ST11.

Then, the control unit 14 judges whether one cycle of a time-slot system is finished or not, as ST12. When one cycle is not finished, the operation returns to ST7. In this way, the control unit 14 counts the numbers A, B and C of successfully-read slots, empty slots and all slots by the counter 17, 18 and 19, respectively.

When one cycle is finished, the control unit 14 calculates the estimated value te by substituting the counted values B and C, and the number of slots S assigned by the start signal start.n of the corresponding one cycle into the formula (11) (an estimated value calculation means), as ST13. Then, the control unit 14 sets this estimated value te in the estimated number memory 16.

However, this estimated value te is a value at the time of starting the corresponding one cycle. Therefore, the control unit 14 updates the estimated value te of the estimated number memory 16 to a value (te−A1) that is subtracted only by the counted value A1 (an estimated number update means), as ST14.

Then, the control unit 14 judges whether to finish the identification information reading operation, as ST15. For example, if a cycle in which all slots are empty is repeated by N(N≧1) times, the control unit 14 judges it to be the end of operation. If the control unit 14 cannot judge the end of operation, the control unit 14 returns to the operation of ST2, and executes the next one cycle.

However, in this case, the counted value n of the cycle number counter 20 is other than “1”, and the nth cycle of time-slot system is started. Namely, the control unit 14 searches the correlation data memory 15 by the estimated value te of the estimated number memory 16, as ST16, and selects the minimum value t1(i) not less than the estimated value te. Further, the control unit 14 reads the number of slots S(i) set in the correlation data memory 15 in response to the value t1(i) (a retrieving means), as ST17. Then, the control unit 14 sends the transmission/reception processor 12 a cycle start signal start.n for assigning the number of slots S(i) to the response device 4 (a sending means), as ST18. Then, the control unit 14 executes the operations on and after ST7.

When the control unit 14 judges that the reading operation is finished in ST15, the control unit finishes the identification information reading operation of that time.

For example, the initial value of the number of slots set in the radio communication apparatus 1 is set to “8”. Assume that six response devices 4A-4F exist in the communication area 3 of the antenna 2, and the signal transmission/reception pattern between the radio communication apparatus 1 and response devices 4A-4F in the first cycle is as shown in FIG. 2.

In this case, the time to receive the assigned slots No. s1-s7 is the time counted by the slot number counters 17, 18 and 19. The time to receive the assigned slot No. s8 is the time required to determine the next number of slots. The number of successfully-read slots A1 is “2”, the number of empty slots B is “3”, and the number of all slots C is “7”. The initial value of the number of slots S is “8”.

Therefore, when obtaining the estimated value te by the formula (11), the estimated value te is “6.345 . . . ”. Further, as the number of successfully-read slots A1 is “2”, the estimated value (te−A1) is “4.345 . . . ”, and this value is set in the estimated number memory 16. As the number of unread response devices is 0 or an integer equal or to larger than 1, the estimated value te=“4” may be set in the estimated number memory 16 by dropping the fractional portion of the number.

The correlation data memory 15 is then searched by the estimated value te=“4.345 . . . ” or “4”, before starting the next cycle, and the minimum value t1(i) not less than the estimated value te is detected. According to the detected value t1(i), the number of slots S(i) set in the correlation data memory 15 is read.

Assuming that the data of the correlation data memory 15 is as shown in FIG. 5, the minimum value t1(i) becomes “5” (i=2). Therefore, “4” (i=2) is read as the number of slots S(i). As a result, the cycle start signal start.2 for assigning the number of slots “4” to the response device 4 is sent over the air in the next cycle.

As described above, according to the first embodiment, the estimated number te of unread response devices is calculated by using the formula (11) simplifying the formula (8) corresponding to a conventional method of calculating an estimated number of unread response devices. Therefore, the calculation load of the radio communication apparatus 1 can be largely reduced.

Further, the number of slots A in the next cycle is determined by the data of the correlation data memory 15. This does not cause a calculation load. Therefore, even a low-class model having a low computing capacity can be used as a radio communication apparatus 1, and a system can be realized at low cost.

The formula (5) is a binomial distribution taking 0 as a variate. It is known that a binomial distribution taking a variate X can be approximated by Poisson distribution taking a probability variable X. Therefore, the estimated number te of unread response devices is obtained by the following formula (12), by substituting the probability approximated by the Poisson distribution into the formula (10),
te=−S(ln B−ln C) (12)

The estimated number te of unread response devices can also be obtained by using the formula (12) instead of the formula (11). In this case, also, a calculation load can be reduced compared with a conventional method.

In ST16 of FIG. 7, the minimum value t1(i) not less than the estimated value te is selected by searching the correlation data memory 15. However, a method of obtaining the minimum value is not limited to this. In ST16, the value t1(i) may be calculated by using the formula (2), and the number of slots S(i) corresponding to this value t1(i) may be read from the correlation data memory 15. In this case, also, a calculation load for calculating the estimated value te of unread response devices is reduced, and a calculation load of the radio communication apparatus 1 can be reduced more efficiently than in a conventional method.

In ST14 of FIG. 7, the estimated value te is updated to (re−A1) by subtracting the number of successfully-read slots A1 from the estimated value te obtained by the formula (11). However, a method of obtaining the number of slots is not limited to this. The next number of slots S may be determined by using the estimated value te calculated by using the formula (11), or the estimated value te of unread response devices at the time to start the period of counting the number of slots. Namely, the operation of ST14 in FIG. 7 may be omitted. In this case, the successfully-read slot number counter 17 can be omitted.

### EMBODIMENT 2

Where it is necessary to detect at least one of collision and empty slots, except for a successfully-read slot, for estimating the number of unread response devices t, slots other than a successfully-read slot can be discriminated from a radio wave intensity when receiving the slots. However, the circuit scale of the radio communication apparatus 1 is inevitably increased for detecting a wave intensity and discriminating a slot from the wave intensity.

In the second embodiment, a method of estimating the number of unread response devices without detecting collision and empty slots will be explained. The parts common to the first embodiment are given the same reference numerals, and detailed explanation of these parts will be omitted.

In the second embodiment, it is assumed that a probability density function taking the number of response devices 4 existing in the communication area 3 of the antenna 2 as a probability variable is known. As a concrete example of the case that a probability density function is known, there is an inspection of arrived goods by reading the identification information of response devices attached to goods.

Goods to receive are products ordered by a purchaser from a supplier. Therefore, the number of products supplied with a response device in one carton box or pallet, or in unit of collective reading upon inspection, is previously known. Therefore, a relative frequency taking the number of response devices in one collective reading unit as a class value is known, and this is substituted for the probability density function. The collective reading unit corresponds to the communication area 3 of the antenna 2. The number of response devices in the collective reading unit corresponds to the number of response devices in the communication area 3.

In the second embodiment, since the radio communication apparatus 1 sends a first cycle start signal start.1 to a group of response devices in a collective reading unit, the number of identification information read from the response device 4 is assumed to be the number Tr of successful readings. The number of response devices 4 existing in the communication area 3 of the antenna 2 is assumed to be ts. A probability density function taking the number Tr of successful readings and number ts of response devices as probability variables is expressed as ftr(Tr, ts), and a function of distribution is expressed as Ftr(Tr, ts). When ts<Tr, ftr(Tr, ts)=0 and Ftr(Tr, ts)=0.

First, the above probability density function ftr(Tr, ts) is ftr(0, ts), because the number Tr of successful readings is “0” before the first cycle start signal start.1 is sent. Therefore, in the second embodiment, ftr(0, ts) is assumed a known value. In this case, Ftr(0, ts) is also a known value.

Next, consider the case that the identification information reading operation advances halfway and the number of successful readings Tr becomes “1” or more. In this case, the response device 4 existing in the communication area 3 of the antenna 2 is at least more than the number of successful readings Tr. Therefore, in the function ftr(Tr, ts) of probability density taking the number of response devices ts as a probability variable, a probability value that the value of the number of response devices ts is less than the value of the number of successful readings Tr becomes “0”.

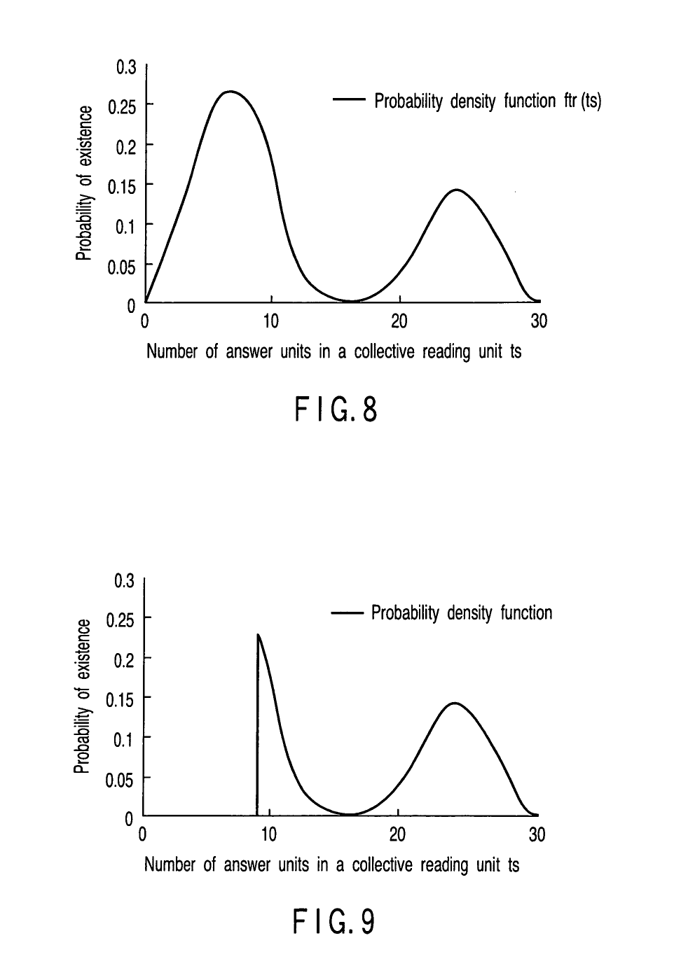

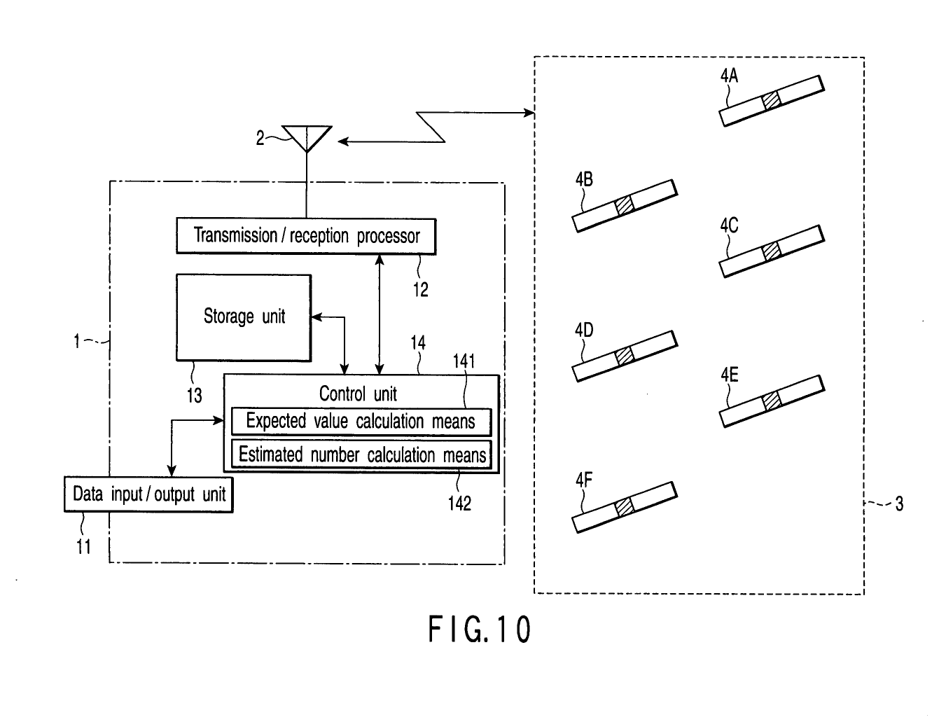

FIG. 8 shows an example of a probability density function ftr(0, ts) taking the number of response devices ts existing in the communication area 3 of the antenna 2 as a probability variable. FIG. 9 shows the case that a range of the number of response devices “0” to the number of successful readings “Tr” is removed from the graph of FIG. 8. The area of the graph of FIG. 9 is [1−Ftr(0, Tr)], and is smaller than an integer “1”.

Next, consider the case that a possible value of the number of response devices ts is not less than the number of successful readings Tr. In this case, the value of a probability density function ftr(Tr, ts) is proportional to the value of the probability density function in FIG. 9. A probability density function ftr(Tr, ts) that a possible value of the number of response devices ts is not less than the number of successful readings Tr is expressed by the following formula (13).

$$\begin{matrix}ftr ( Tr , ts ) = \frac{ftr ( 0 , ts )}{1 - Ftr ( 0 , Tr )} & ( when ts \geq Tr ) \\ ftr ( Tr , ts ) = 0 & ( when ts < Tr ) \end{matrix} \} \qquad ( 13 )$$

A denominator when ts≧Tr in the formula (13) corresponds to the area of the graph of FIG. 9. This value is used for adjustment of the number of response devices ts in the formula (13), so that a value integrating the number of successful readings Tr to infinity becomes 1. By using the formula (13), an expected value E[ts, ts≧Tr] of the number of response devices ts is calculated in the case that a possible value of the number of response devices ts becomes not less than the number of successful readings Tr. The expected value E[ts, ts≧Tr] is expressed by the following formula (14).

$$E [ ts , ts \geq Tr ] = {\int }_{Tr}^{∞} ts \times ftr ( Tr , ts ) ⅆ ts \qquad ( 14 )$$

The number of successful readings Tr is then subtracted from the expected value E[ts, ts≧Tr] of the number of response devices ts when the possible value obtained by the formula (14), that is, the possible value of the number of response devices ts becomes not less than the number of successful readings Tr. The obtained difference value is taken as the estimated number te of unread response devices. Therefore, the estimated number te of unread response devices is expressed by the following formula (15).
te=E[ts,ts≧Tr]−Tr (15)

In the second embodiment, as shown in FIG. 10, an expected value calculation means 141 included in the control unit 14 calculates the expected value E[ts, ts≧Tr] by using the formula (14). An estimated number calculation means 142 calculates the estimated number te of unread response devices by using the formula (15). In the second embodiment, the number of unread response devices t can be estimated as an estimated number te, without detecting neither a collision slot nor an empty slot, as explained above.

After estimating the number of unread response devices as explained above, the radio communication apparatus 1 obtains the minimum value min[t1(i)] not less than the estimated value t, by using the minimum value calculation means, by comparing the estimated value t with the value t1(i){i=1, 2, . . . , n} calculated by the formula (2), (3) or (3). Further, the radio communication apparatus 1 determines, by a deciding means, the number of time slots S(i), which is smaller than S(i+1), taking this minimum value min[t1(i)] as a new number of slots S.

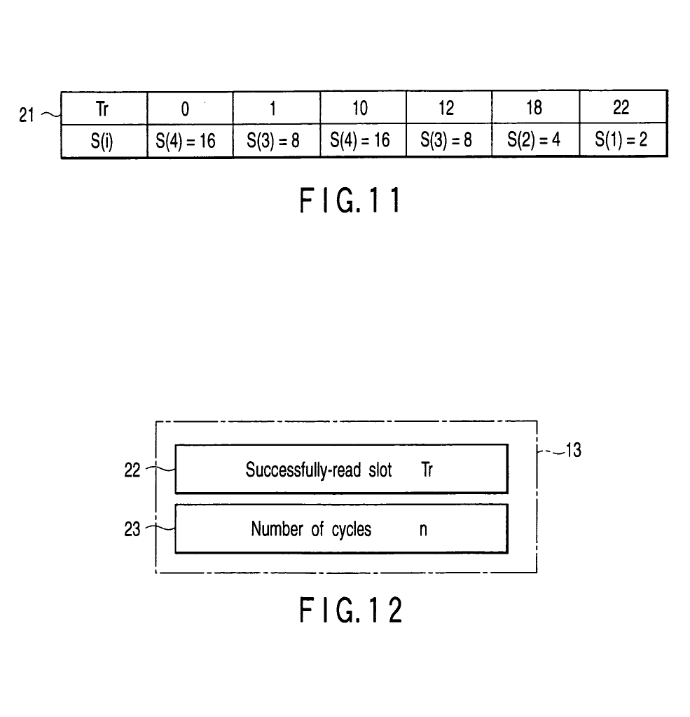

The estimated number te of unread response devices is the function Tr of the number of successful readings. In the second embodiment, as shown in FIG. 11, a correlation data memory 21 is formed by correlating the number of successful readings Tr with the number of corresponding selectable time slots S(i) {i=1, 2, . . . , n}.

The correlation data memory 21 shown in FIG. 11 provides only the number of successful readings Tr obtained when the number of slots S(i) is different from the number of preceding successful readings Tr−1, among the numbers of successful readings Tr 0 to 30. For example, the value S(S(4)=16) where the number of successful readings Tr is “10” comes next to the value S(S(3)=8) where the number of successful radings Tr is “1”. This means that the value S is 8 when 1≦Tr<10, and the value S is changed to 16 when Tr=10.

In the second embodiment, the correlation data memory 21 is stored in the storage unit 13 of the radio communication apparatus 1. The storage unit 13 of the radio communication apparatus 1 includes a successfully-read slot number counter 22 and a cycle number n counter 23 as shown in FIG. 12. The successfully-read slot number counter 22 counts the number of successfully read slots corresponding to the number of successful readings Tr.

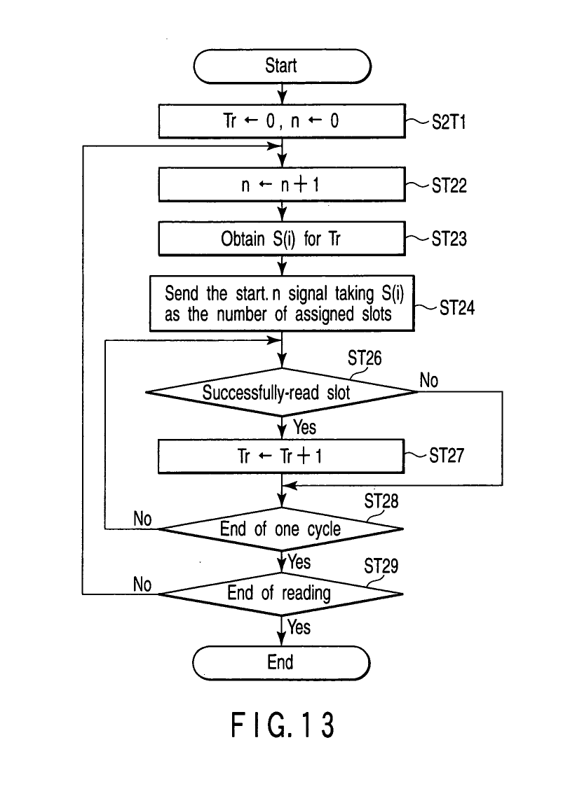

The control unit 14 of the radio communication apparatus 1 executes reading the identification information of the response devices existing in the communication area 3 of the antenna 2, according to the procedure shown in the flowchart of FIG. 13.

The control unit 14 resets the counted values Tr and n of the counters 22 and 23 to “0”, as ST21, and counts up the cycle number counter 23 by “1”, as ST22.

The control unit 14 searches the correlation data memory 21 by the counted value Tr of the successfully-read slot number counter 22, as ST23, and reads the number of slots S(i) set corresponding to that counted value Tr (a retrieving means).

The control unit 14 sends a cycle start signal start.n (n: a counted value n of the cycle number counter 23) to the transmission/reception processor 12, as ST24. The cycle start signal start.n assigns the number of slots S(i) to each response device 4 (a sending means).

The control unit 14 judges whether the identification information can be demodulated from that signal, as ST26. When the identification information can be demodulated, the slot of that signal is taken as a successfully-read slot. The control unit 14 counts up the counted value Tr of the successfully-read slot number counter 22 by “1”, as ST27.

If the identification cannot be demodulated from the slot signal in ST26, the control unit 14 does not execute the operation of ST27.

The control unit 14 judges whether one cycle of a time-slot system is finished or not, as ST28. When one cycle is finished, the control unit 14 judges whether to finish the identification information reading operation, as ST29. For example, when a successfully read slot is not obtained continuously for a predetermined number k (k>1), the control unit judges that the operation is finished. If the control unit cannot judge that the operation is finished, the control unit returns to the operation of ST22, and executes the next one cycle.

When the control unit 14 judges that the reading operation is finished in ST29, the control unit finishes the identification information reading operation of that time.

Assume the inspection of goods in a shop as a concrete example of this embodiment. Goods are inspected in a shop by placing pallets filled with goods one by one in the communication area 3 of the antenna 2, and reading the identification information of the response devices 4 attached to the goods on the pallets by the radio communication apparatus 1. In this time, a shop already knows the goods that are to be delivered on a certain day because the shop has ordered those goods from a supplier.

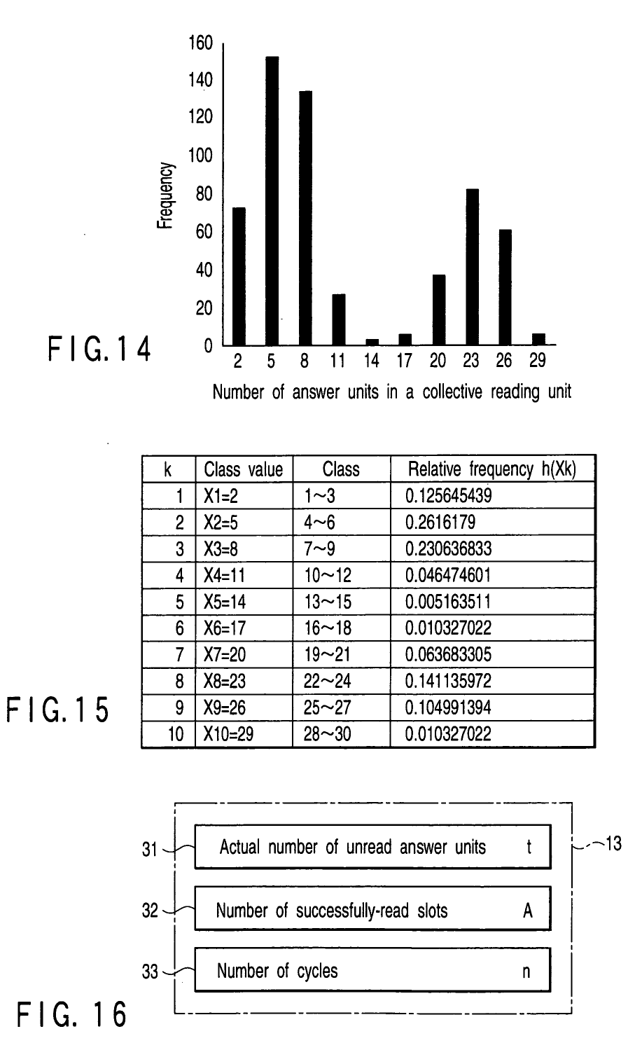

In this example, the number of response devices for each goods pallet to be delivered is a class value, and the number of goods pallets to be delivered in each class is a frequency, as shown in a histogram of FIG. 14.

First, a probability density function ftr(O, ts) taking the number of response devices ts in the communication area 3 of the antenna 2 as a probability variable, is obtained from the histogram of FIG. 14. The horizontal axis of the histogram indicates a class value Xk of the number of response devices ts in a collective reading unit, and the vertical axis indicates a frequency h(Xk). The class value Xk is expressed by 3k−1{k=1, 2, . . . , 10}.

A table of relative frequency distribution of FIG. 15 is then created from the histogram of FIG. 14. The probability density function ftr(O, ts) taking the number of response devices ts in the communication area 3 of the antenna 2 as a probability variable, is defined by the relative frequency distribution table and the following formula (16).
ftr(0,ts)=h(Xk)/d{Xk−d/2≦ts<Xk+d/2} (16)

A function of distribution Ftr(0, ts) is defined by the following formula (17).

$$Ftr ( 0 , ts ) = {\sum }_{x = 0}^{ts} ftr ( 0 , x ) \qquad ( 17 )$$

The value d in the formula (16) is a value between the classes in the histogram of FIG. 14, and “3” in this example. When the number of response devices ts is smaller than “0”, the probability density function ftr(0, ts) is “0”, and the function of distribution Ftr (0, ts) is also “0”.

By substituting the formulas (16) and (17) into the formula (13), the probability density function ftr(Tr, ts) is defined. In this example, as ftr(0, ts) and ftr(Tr, ts) are obtained from the histogram, they are the functions of probability mass, and the number of response devices ts is 0 or an integer equal or to larger than 1. Therefore, the function of probability mass ftr(Tr, ts) is expressed like the following formula (18) by ftr(0, ts) in the formula (16) and Ftr(0, ts) in the formula (17).

$$\begin{matrix}ftr ( Tr , ts ) = \frac{ftr ( 0 , ts )}{1 - Ftr ( 0 , Tr - 1 )} & ( when ts \geq Tr ) \\ ftr ( Tr , ts ) = 0 & ( when ts < Tr )\end{matrix} \} \qquad ( 18 )$$

An expected value of the number of response devices ts is expressed by the following formula (19), instead of the formula (14).

$$E [ ts , ts \geq Tr ] = {\sum }_{ts = Tr}^{∞} \{ ts \times ftr ( Tr , ts ) \} \qquad ( 19 )$$

The formula (19) is an equation to sum up until the number of response devices ts becomes infinity. However, in this example, a maximum value of the number of response devices is known as “30” from the relative frequency distribution table of FIG. 15. Therefore, the formula (19) may sum up to ts≦30.

By substituting the formula (19) into the formula (15), the estimated number te of the number of unread response devices can be obtained. The estimated number te is then compared with the value t1(i){i=1, 2, . . . , n}, and the minimum value min[t1(i)] not less than the estimated number te is obtained. The number of time slots S(i), which is smaller than the number of time slots S(i+1), is then determined by taking this minimum value min[t1(i)] as a new number of slots S.

On the other hand, the range obtainable by the number of successful readings Tr is known as “0” to “30” from the relative frequency distribution table of FIG. 15. Therefore, the number of time slots S(i) {i=1, 2, . . . , n} for each number of successful readings Tr in this range is obtained, and the correlation between the number of successful readings Tr and the number of time slots S(i) is expressed as shown in FIG. 11. In this example, the value t1(i){i=1, 2, 3, 4} is obtained by assuming the first term a to be 2 and the equal ratio r to be 2 in the formula (4).

In this concrete example, data indicating the correlation between each Tr and S(i) shown in FIG. 11 is calculated outside the radio communication apparatus 1. And, the calculation result is written in the correlation data memory 21 of the storage unit 13.

The radio communication apparatus 1 reads the number of slots S(i) corresponding to the number of successful readings Tr from the correlation data memory 21, and assigns the number of slots S(i) to each response device. This increases the identification information reading efficiency.

As described above, in the second embodiment, the information necessary for selecting the number of slots by the radio communication apparatus 1 is only the number of identification information obtained by the radio communication apparatus 1 in a collective reading unit. Therefore, it is unnecessary to detect collision and empty slots, other than a successfully-read slot, and the circuit scale of the radio communication apparatus 1 can be reduced.

By previously inputting the histogram information and data indicating the correlation between t1(i) and S(i) to the control unit 14, the control unit 14 may calculate the correlation between Tr and S(i) from the input data, and write the result in the correlation data memory 21.

In the correlation data memory 21 shown in FIG. 11, the number of slots S(i) is increased when he number of successful readings Tr=10. This is caused because the histogram of FIG. 14 has two peaks. Namely, when the number of successful readings Tr=4, the frequency before and after the class value “5” is large, and the estimated value te of the number of unread response devices becomes small (about 9.1). Contrarily, when the number of successful readings Tr=10, the influence of the frequency before and after the class value “23” as a second peak is large, and the estimated value te of the number of unread response devices becomes large (about 11.7). Therefore, when the number of successful readings Tr=10, the number of slots S(i) is increased.

The formula (14) is an equation for calculating an expected value E[ts, ts≧Tr] of the number of response devices ts when a value obtainable by the number of response devices ts is not less than the number of successful readings Tr. This equation multiplies and sums up (integrates) a value obtainable by the number of response devices ts and a probability ftr(Tr, ts) to become that value, according to a means for calculating a normal expected value.

As other embodiments, a median of a probability density function in the formula (13) may be taken as an expected value E[ts, ts≧Tr]. This can further decrease the load required for calculation.

The median becomes the number of response devices ts satisfying the following formula (20).

$${\int }_{Tr}^{ts} ftr ( Tr , ts ) ⅆ ts = \frac{1}{2} \qquad ( 20 )$$

The probability P1(S(i), t) is a probability that when slots of the number S(i) are specified, the number of response devices 4 to send identification information to one slot is 1. The probability P1(S(i+1), t) is a probability that when slots of the number S(i+1), the next larger value of the number S(i), are specified, the number of response devices 4 to send identification information to one slot is 1. The value t1(i){i=1, 2, . . . , n} of unread response devices with which these probabilities P1(S(i), t) and P1(S(i+1), t) become equal can be calculated by any one of the formulas (2), (3) and (4).

However, the value t1(i) varies depending on the communication environments of the radio communication apparatus 1 and response device 4. Therefore, the value t1(i) may be obtained from a calculation value by simulation or by experiment in the actual operating environment. Namely, this embodiment is not limited by the method of setting the value t1(i).

### EMBODIMENT 3

In the second embodiment, the estimated number te of unread response devices is obtained first. Then, based on the estimated value te, a new number of slots S specified by the radio communication apparatus 1 is selected from selectable number of slots S(i){i=1, 2, . . . , n}. In this case, robustness is not considered when there is an error between the estimated number te of unread response devices and number of actual response devices.

An explanation will next be given on a third embodiment considering the error. Also, in the third embodiment, a probability density function taking the number ts of response devices existing in the communication area 3 of the antenna 2 is previously known. The parts common to the second embodiment are given the same reference numerals, and detailed explanation of these parts will be omitted.

In the third embodiment, a new number of slots S specified by the radio communication apparatus 1 is S(i){i=1, 2, . . . , n} to maximize the following formula (21).

$${\int }_{Tr}^{∞} P 1 ( S ( i ) , ts - Tr ) \times ftr ( Tr , ts ) ⅆ ts \qquad ( 21 )$$

The P1(S(i), ts-Tr) in the formula (21) indicates the probability of occurrence of successfully-read slots per one slot, taking the number of unread response devices [ts-Tr] and a new number of slots S(i) specified by the radio communication apparatus 1 as arguments. Therefore, the equation defined by the formula (1) can be inserted. The value of P1(S(i), ts-Tr) varies depending on the communication environments of the radio communication apparatus 1 and response device 4. Therefore, the value of P1(S(i), ts-Tr) may be obtained by calculation by simulation or by experiment in the actual operating environment.

The ftr(Tr, ts) in the formula (21) is a probability density function defined by the formula (13). The ftr(Tr, ts) can also be replaced by a formula set up by a function of probability mass shown in the formula (18), as in the second embodiment. In this case, as a function of probability mass is a discrete function, a total sum is calculated by the formula (21), instead of integration.

The probability P1(S(i), t) can be defined by a binomial distribution and Poisson distribution, as described hereinbefore. Further, it can be defined also by a hypergeometric distribution where the probability of occurrence of event is 1/S(i), the number of attempts is t, and the variate is one time.

Therefore, an equation substituting [ts-Tr] into the argument t can be used as P1(S(i), ts-Tr) in the formula (21).

The formula (21) is a function of successful readings Tr. The number of selectable slots S(i){i=1, 2, . . . , n} is previously calculated to maximize the formula (21) for the number of successful readings Tr. The number of successful readings Tr and the corresponding number of slots S(i) are correlated and stored in the storage unit 13.

When starting reading of the identification information of the response device 4, the radio communication apparatus 1 obtains the number of successful readings Tr and number of corresponding slots S(i) from the storage unit 13, and sends a signal for assigning the obtained number of slots S(i) to each response device 4. This reduces the calculation load of the radio communication apparatus 1 compared with a conventional method.

In the third embodiment, also, the information necessary for selecting the number of slots by the radio communication apparatus 1 is only the number of identification information obtained by the radio communication apparatus 1 in a collective reading unit. The third embodiment provides similar effects to the second embodiment.

In the second and third embodiments, the probability density function ftr(0, ts) taking the number of response devices ts in the communication area 3 of the antenna 2 as a probability variable is already known. However, the probability density function ftr(0, ts) may be approximated by various probability distributions. For example, for operational convenience, when an expected value and a variance of the number of response devices ts are known, the probability density function ftr(0, ts) can be approximated by a normal distribution.

When an expected value and a maximum obtainable value of the number of response devices ts are known, the probability density function ftr(0, ts) can also be approximated by a hypergeometric distribution, binomial distribution and Poisson distribution, where an average of the number of occurrence of event becomes an expected value of the number of response devices ts and the number of occurrence of attempt becomes a maximum value of ts.

When a maximum obtainable value of the number of response devices ts is known, the probability density function ftr(0, ts) can also be approximated by an uniform distribution in a range of 0 to a maximum value of the number of response devices ts.

A maximum value of the number of response devices ts can be defined by a radio wave output from the radio communication apparatus 1, when a communication radio wave from the radio communication apparatus 1 is used as an electromotive force of the response device 4 as a passive RFID, for example. For operational convenience, an upper limit of the number of response devices ts is sometimes definite.

In these cases, formulas of models of various probability distributions are stored taking the number of response devices ts as a probability variable in the storage unit 13 of the radio communication apparatus 1. According to methods of operating the radio communication apparatus 1, the parameters of various probability distributions, the correlation between t1(i) and S(i) or a definition formula of P1(S(i), ts-Tr) are input to the control unit 14 of the radio communication apparatus 1 through the data input/output unit 11. The control unit 14 calculates the correlation between t1(i) and S(i) from the input data, and stores the result in the storage unit 13 of the radio communication apparatus 1.

The parameters of various probability distribution described above are an expected value and variance of the number of response devices ts in the case of normal distribution. In any of hypergeometric distribution, binomial distribution and Poisson distribution, the parameters are maximum obtainable values of the number of response devices ts (values of the number of attempts in the hypergeometric distribution, binomial distribution and Poisson distribution), and an expected value of ts. In the uniform distribution, the parameter is a maximum obtainable value of the number of response devices ts.

When obtaining the probability density function ftr(Tr, ts) taking the number of response devices ts as a probability variable from the histogram of FIG. 14, as described above, the correlation between Tr and S(i) stored in the storage unit 13 by the radio communication apparatus 1 is as shown in FIG. 11.

The correlation of FIG. 11 is calculated based on a method of calculating the correlation between Tr and S(i) shown in the second embodiment. When calculating the correlation between Tr and S(i) shown in the third embodiment, ftr(Tr, ts) of the formula (18) is substituted into the formula (21). However, note that ftr(Tr, ts) of the formula (18) is a function of probability mass. Therefore, S(i), which maximizes the formula (22) instead of the formula (1), is taken as S(i) corresponding to Tr.

$${\sum }_{ts = Tr}^{∞} P 1 ( S ( i ) , ts - Tr ) \times ftr ( Tr , ts ) \qquad ( 22 )$$

The formula (22) is an equation to sum up until the number of response devices ts becomes infinity. However, when the probability density function ftr(Tr, ts) is defined, it is seen from the relative frequency distribution table of FIG. 15 that a maximum value of the number of response devices ts is 30, and the formula (22) may sum up to ts≦30.

### EMBODIMENT 4

Each time a time slot is assigned to each response device, the conventional radio communication apparatus executes predetermined calculation. Since the conventional apparatus has to repeat complex operations again and again, it requires a high operation capacity.

An explanation will be given of a fourth embodiment, which is intended to enhance the operation capacity. The parts common to the foregoing embodiments are given the same reference numerals, and detailed explanation of these parts will be omitted.

The fourth embodiment indicates a case that the radio communication apparatus 1 previously has information on the number of response devices 4 existing in the communication area 3 of the antenna 2. If the radio communication apparatus 1 previously has the information, it is possible to calculate the number of residual unread response devices t by subtracting the number of successfully-read slots from that number.

In the fourth embodiment, the correlation data memory 15 shown in FIG. 5 is stored in the storage unit 13 of the radio communication apparatus 1. Further, as shown in FIG. 16, a counter 31 (an actual number memory) of the actual number of unread response devices t, a counter 32 of the number of successfully-read slots A, and a counter 33 of the number of cycles n are formed in the storage unit 13.

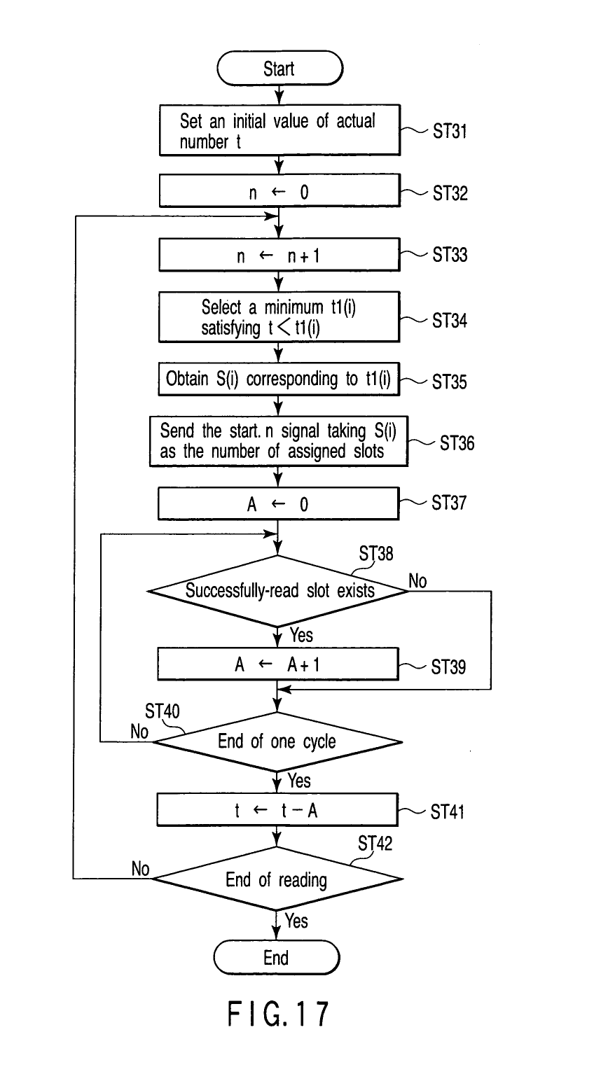

The control unit 14 of the radio communication apparatus 1 executes reading identification information of the response devices 4 existing in the communication area of the antenna 2, according to the procedure shown in the flowchart of FIG. 17.

The control unit 14 first sets an initial value Ts of the actual number of unread response devices t in the counter 31. The initial value Ts is a total number of the response devices 4 existing in the communication area of the antenna 2, and input from an external unit connected through the data input/output unit 11, for example.

The control unit 14 once resets a counted value n of the cycle number counter 33 to “0”, as ST32. Then, the control unit counts up the cycle number counter 33 by “1”, as ST33. Namely, the control unit starts a first cycle of a time-slot system.

The control unit 14 searches the correlation data memory 15 by the counted value t of the unread answer actual number counter 31, as ST34, and selects a minimum value t1(i) that is not less than the counted value t. The control unit 14 reads the number of slots S(i) set in the correlation data memory 15 corresponding to the value t1(i) (a retrieving means), as ST35. The control unit sends the transmission/reception processor 12 a cycle start signal start.n for assigning this number of slots S(i) to each response device 4 (a sending means), as ST36.

The control unit 14 resets the counted value A of the successfully-read slot number counter 32, as ST37. Then, the control unit judges whether the received slot is a successfully-read slot, as ST38. When the received slot is a successfully-read slot, the control unit counts up the counted valve A of the successfully-read slot number counter 32 by “1”, as ST39.

The control unit 14 judges whether one cycle of a time-slot system is finished or not, as ST40. If the cycle is not finished, the operation returns to ST38. In this way, the control unit 14 counts the number of successfully-read slots received before one cycle is finished, by the successfully-read slot number counter 32.

When one cycle is finished, the control unit 14 subtracts the counted value A of the successfully-read slot number counter 32 from the counted value t of the unread response device actual number counter 31, as ST41. Namely, the control unit updates the counted value t to the latest actual number of unread response devices (an actual number updating means).

The control unit 14 judges whether to finish the identification information reading operation, as ST42. For example, when a cycle that every time slot is empty is continued by N times (N≧1), the control unit judges that the reading operation is finished. If the reading operation is not judged finished, the control unit returns to the operation of ST33, and executes the next cycle.

When the control unit 14 judges that the reading operation is finished in ST42, the control unit finishes the identification information reading operation of that time.

As described above, in the fourth embodiment, the radio communication apparatus 1 obtains an optimum number of slots for reaching identification information of each response device 4 from the correlation data memory 15, and the cost and calculation load can be reduced.

In the fourth embodiment, when the number of response devices 4 is input from an external unit, the control unit 14 starts reading of identification information. A trigger to start the reading operation is not limited to this. For example, when the radio communication apparatus 1 previously stores the number of response devices 4, the identification information reading operation may be started in response to a read start command from an external unit.

### EMBODIMENT 5

Estimation of the number of unread response devices whenever there occurs timing to determine a new number of slots is based on when the number of slots is the same as the number of unread response devices or when the rate of occurrence of successfully-read slots is maximum (slightly below 37%). Namely, the rate of occurrence of successfully-read slot is high when the ratio of the difference between actual number and estimated number of unread response devices is small, and low when the difference is large.

For example, consider a case that the actual number of unread response devices is 30 and the estimated number is 25 at the beginning. In this case, the ratio of the difference between the actual number and estimated number is 1.2. Assume that the identification information of 20 response devices is read thereafter. At this point of time, the actual number of unread response devices is 10, the estimated number is 5, and the ratio rises up to 2.0. Thus, the rate of occurrence of successfully-read slot is high at first, but becomes low as the number of successfully-read slots increases.

A radio communication apparatus of this type usually finishes the reading operation when the number of successfully-read slots does not increase for a certain time. On the other hand, when the initial estimated number of unread response devices is less than the actual number, the rate of occurrence of successfully-read slot decreases as time passes. Thus, even if there remains an unread response device, as the number of successfully-read slots is not increased for a predetermined period, the reading operation may be finished.

To solve this problem, the fifth embodiment provides a radio communication apparatus which can reduce the possibility of failing to read identification information to a minimum even if the estimated number of unread response devices is less than the actual number. The parts common to the foregoing embodiments are given the same reference numerals, and detailed explanation of these parts will be omitted.

In the fifth embodiment, when the number of unread response devices t becomes less than optional predetermined number K, thereafter the number of slots assigned to each response device 4 is fixed. Therefore, the number of assigned slots immediately before the end of the reading operation becomes a certain degree not less than the number of unread response devices t. This can reduce the possibility of failing to read identification information to a minimum.

Such an operation mode is called a fixed mode. The state of the radio communication apparatus 1 before shifting to the fixed mode is called a variable mode. The certain number K is a set value. Hereinafter, this certain number K is called a switching set value. The switching set value K is set to 0.2 or 0.3 times an initial estimated number of unread response devices E[te] for example. Therefore, the number of unread response devices before failure to read identification information easily occurs can be set.

The fifth embodiment will be concretely explained hereinafter. In the fifth embodiment, it is assumed that the radio communication apparatus 1 cannot discriminate between an empty slot and a collision slot. In this case, when the number of successfully-read slots Tr is not increased for a certain period, the radio communication apparatus 1 judges that the identification information of all response devices 4 existing in the communication area 3 of the antenna 2 has been read, and finishes the reading operation.

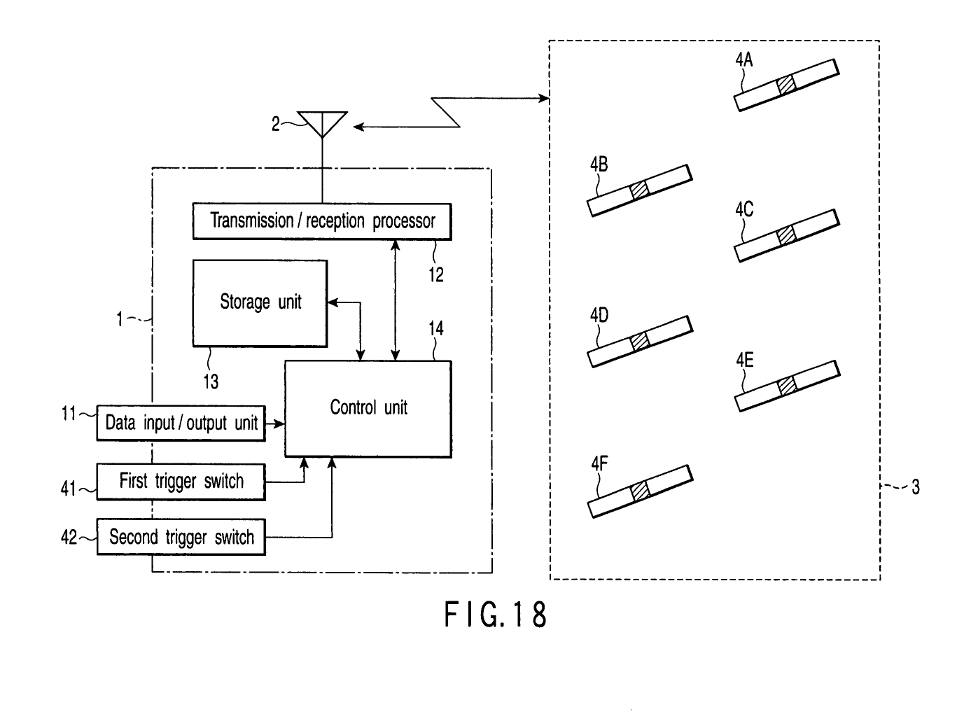

FIG. 18 is a block diagram of a radio communication system in the fifth embodiment. The parts common to those of FIG. 1 are given the same reference numerals.

As shown in FIG. 18, the radio communication apparatus 1 of the fifth embodiment has a first trigger switch 41 and a second trigger switch 42, in addition to a data input/output unit 11, a transmission/reception processor 12, a storage unit 13, and a control unit 14.

The first trigger switch 41 constitutes a first trigger generation means. The second trigger switch 42 constitutes a second trigger generation means. These first and second trigger switches 41 and 42 are switches for generating a read start trigger. A trigger signal is input to the control unit 14.

In response to the input of the trigger signal from one of the trigger switches 41 and 42, the control unit 14 starts reading the identification information of the response device 4. The number of response devices 4 in this time, or the number of response devices 4 existing in the communication area 3 before start of the reading operation, is assumed to be a collective reading unit.

For reference, the slot number deciding procedure after starting the reading operation is different when the first trigger switch 41 is input and when the second trigger switch 42 is input. The first deciding procedure when the first trigger switch 41 is input is suitable for a case that the number of response devices 4 is more than the number in the second deciding procedure when the second trigger switch 42 is input. The first and second deciding procedures will be explained later in detail.

The radio communication apparatus 1 is shifted to a fixed mode when the number of unread response devices t becomes less than a set switching value K. An estimated value S(i)fin of the number of slots required until the reading operation is finished after the radio communication apparatus is shifted to the fixed mode, is calculated by the following formula (23).

$$S ( i ) fin = {\sum }_{x = 1}^{t} \frac{1}{P 1 ( S ( i ) , t )} \qquad ( 23 )$$

In the formula (23), S(i){i=1, 2, . . . , n} is the number of slots specified by the radio communication apparatus 1, and t is the number of unread response devices. P1(S(i),t) is the probability of occurrence of successfully-read slots when the number of slots is S(i) and the number of unread response devices is t.

As seen from the formula (23), when the number of slots S(i) is fixed in at certain value, the number of slots required to reduce the number of unread response devices t by one to [t−1] is a reciprocal of the probability of occurrence of successfully-read slot when the number of unread response devices is t.

Therefore, the number of slots required to reduce the number of unread response devices is summed up one by one, sequentially, as in cases when the number of unread response devices is [t−1], [t−2] and on. In so doing, the number of slots required until the reading operation is finished can be calculated.

Then, the number of unread response devices t is divided by the estimated value S(i) fin of the required number of slots. The identification information reading efficiency (throughput) up to the end of the reading operation can be obtained. Namely, the throughput is expressed by the following formula (24).
t/S(i)fin (24)

In the fifth embodiment, the radio communication apparatus 1 selects the number of slots S(i) only immediately after the shifting to the fixed mode. Next, explanation will be given on the method of selecting the number of slots S(i) immediately after shifting to the fixed mode.

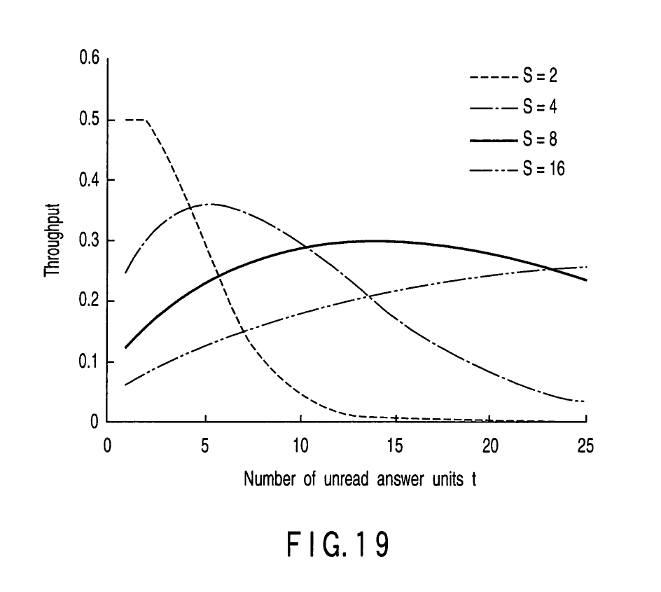

FIG. 19 shows the relationship between the throughput t/S(i) fin{i=1, 2, . . . , n} and the number of unread response devices t when the probability of occurrence of successfully-read slot P1(S(i), t) is expressed by the formula (1). In FIG. 19, the number of slots is S(1)=2, S(2)=4, S(3)=8 and S(3)=16. As seen from FIG. 19, the number of slots S(i) to maximize the formula (24) is different according to the number of unread response devices t.

In the range of the number assignable slots S(i){i=1, 2, . . . , n}, the value with which the number of slots to maximize the formula (24) is changed is obtained from S(i+1) to S(i) as the number of unread response devices t decreases. This value is an integer value T2(i){i=1, 2, . . . , n} of a maximum value to satisfy the relationship of the following formula (25).
t/S(i)fin>t/S(i+1)fin (25)

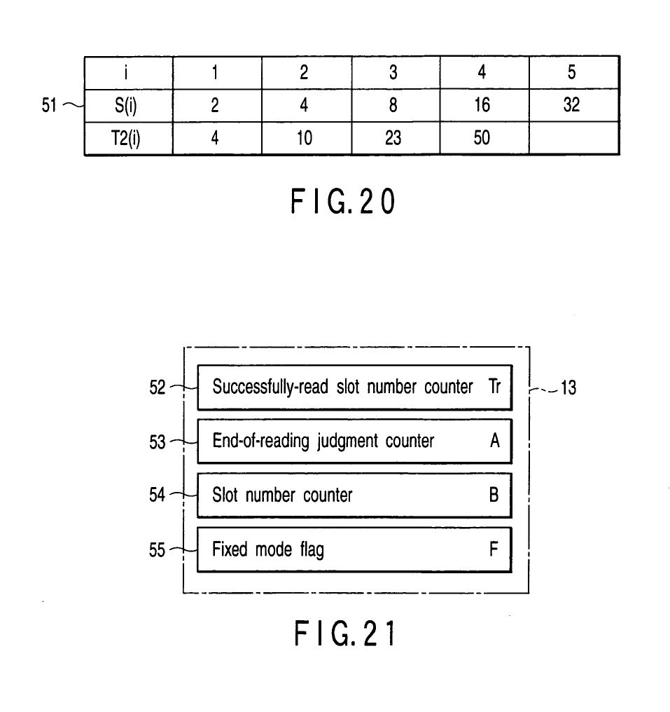

In the fifth embodiment, as shown in FIG. 20, a fixed mode correlation data memory 51 is formed by correlating the integer value T2(i) and the number of slots S(i). This fixed mode correlation data memory 51 is stored in the storage unit 13.

The example of FIG. 20 is a case that there are five numbers of assignable slots S(i), S(1)=2, S(2)=4, S(3)=8, S(4)=16 and S(5)=32. In this case, when i=1, a maximum integer value T2(1) to satisfy the formula (25) (t/S(1)fin>t/S(2)fin) is calculated as “4”. When i=2, the integer value T2(2) is calculated as “10”. When i=3, the integer value T2(3) is calculated as “23”. When i=4, the integer value T2(4) is calculated as “50”. In the fifth embodiment, these values are stored in the fixed mode correlation data memory 51.

The number of slots S(i) selectable by the radio communication apparatus 1 is i=1, 2, . . . , n. Therefore, when i=n, S(i+1) of the formula (23) is not defined. Therefore, as S(i+1)fin of the formula (25) is also not defined, the integer value T2(n) cannot be calculated. Therefore, in the fifth embodiment, the integer value T2(n) is infinity.

When actually selecting the number of slots in the fixed mode, the radio communication apparatus 1 compares the calculated value of the following formula (26) with the integer value T2(i){i=1, 2, . . . , n}, and determines the number of slots.
E[ts]−Tr+α (26)

In the formula (26), E[ts] is an initial estimated number of unread response devices, Tr is the number of successfully-read slots, and “a” is an optional value set in the radio communication apparatus 1. The value “a” is a parameter to determine whether to select the number of slots immediately after shifting to the fixed mode, by estimating the difference between the actual number of unread response devices and the estimated number of unread response devices {E[ts]−Tr}.

As the formula (23) is a discrete function, the probability P1(S(i),t) of the formula (23) can be defined by the binomial distribution or Poisson distribution described before. It can also be defined by a hypergeometric distribution where an expected value is t/S(i), the number of attempts is t, and a variate is one time.

As for the estimated value S(1)fin of the number of slots required until the end of the reading, the following formula (27) can be used instead of the formula (23).

$$S ( i ) fin = {\int }_{1}^{t} \frac{1}{P 1 ( S ( i ) , t )} ⅆ t \qquad ( 27 )$$

In this case, an integer value of a value t that satisfies an equal sign relationship of the following formula (28) when the formula (27) is substituted into the formula (28) is assumed to be T2(i){i=1, 2, . . . , n}.
t/S(i)fin=t/S(i+1)fin (28)

The equal signal relationship of the formula (28) is established even if t=0 or t=infinite. When i=1, 2, . . . , n−1, T2(i) is neither 0 nor infinite. When i=n, T2(n) is infinite.

The radio communication apparatus 1 compares the calculated value of the formula (26) with T2(i){i=1, 2, . . . , n}, and determines the number of assignable slots in the fixed mode.

Next, the first and second decision procedures will be explained based on a concrete example of reading identification information of a passive RFID by a RFID handy scanner. In this example, the scanner corresponds to the radio communication apparatus 1, and the RFID corresponds to the response device 4.

The storage unit 13 of the radio communication apparatus 1 includes the correlation data memory 15 shown in FIG. 5 and the fixed mode correlation data memory 51 shown in FIG. 20. As shown in FIG. 21, the storage unit 13 also includes a counter memory 52 of the number of successfully-read slots Tr, a counter memory 53 of the number of end-of-reading judgment A, a counter memory 54 of the number of slots B, and a memory 55 of a fixed mode flag A.

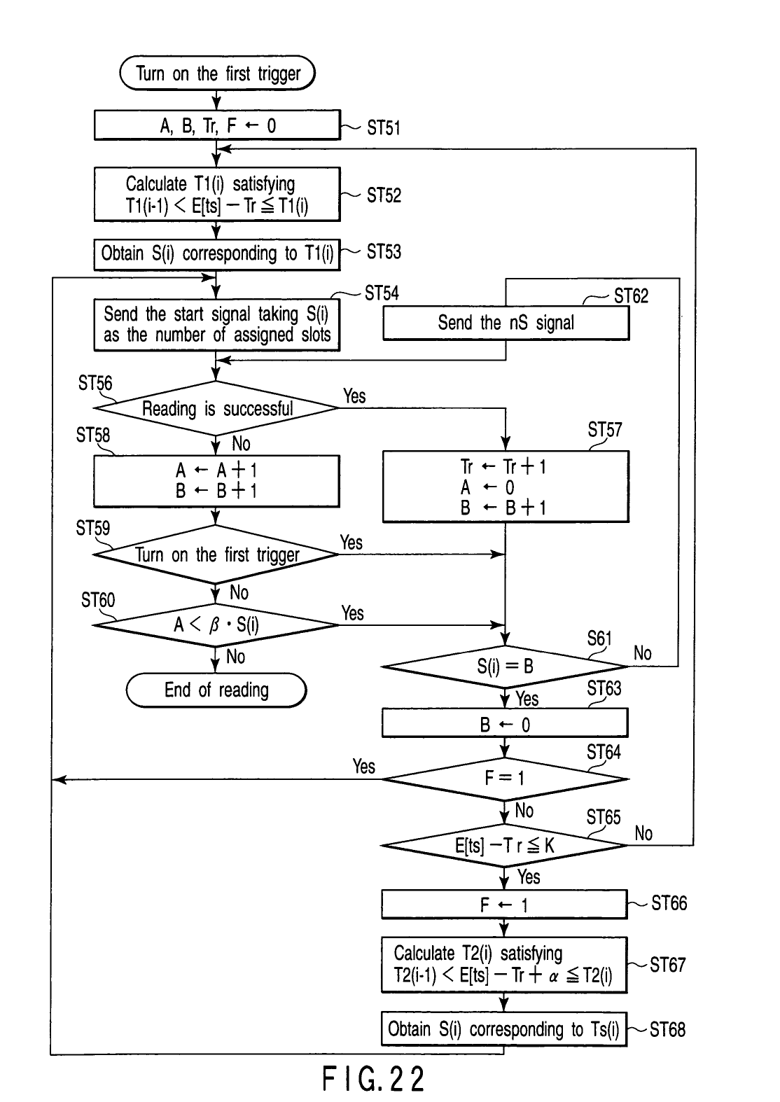

FIG. 22 is a flowchart showing the first decision procedure (a first decision procedure control means). When the ON signal of the first trigger switch 41 is input to the control unit 14, the control unit 14 clears the counter memories 52-54 and flag memory 55, as ST51.

The control unit 14 refers to the correlation data memory 15, and obtains the integer value T1(i) that satisfies the formula ┌T1(i−1)<E[Ts]−Tr≦T1(i)┘, as ST52. In this case, the number of successfully-read slots Tr is “0”. Therefore, obtain the estimated number E[ts], namely the minimum integer value T1(i) that is the integer value T1(i){i=1, 2, . . . , n} not less than the number of RFIDs in a collective reading unit.

The control unit 14 searches the correlation data memory 15, and gains the number of slots S(i) stored corresponding to that integer value T1(i) (a retrieving means), as ST53. And, the control unit 14 sends the transmission/reception processor 12 a cycle start signal for assigning this number of slots S(i) to each response device 4 (a sending means), as ST54.

The control unit 14 judges whether the slot is a successfully-read slot, as ST56.

When the received slot is a successfully-read slot, the control unit 14 counts up the number of successfully-read slots Tr of the counter memory 52 and the number of slots B of the counter memory 54 by “1”, as ST57. The control unit resets the end-of-reading judgment number A of the counter memory 53 to “0”. Then, the control unit goes to the operation of ST61.

If the received slot is not a successfully-read slot in ST56, the control unit 14 counts up the end-of-reading judgment number A of the counter memory 53 and the number of slots B of the counter memory 54 by “1”, as ST58. Then, the control unit judges whether the input of the ON signal of the first trigger switch 41 is continued. When the input is continued, the operation proceeds to ST61.

If the ON signal of the first trigger switch 41 is not input in ST59, the control unit 14 judges whether the number of judgment of reading A reaches the product β·S(i) obtained by multiplying the number of slots S(i) by a predetermined coefficient β (β: an integer equal or to larger than 1), as ST60. If the number of judgment of reading A does not reach the product β·S(i), operation proceeds to ST61.

In ST61, the control unit 14 judges whether the number of slots B of the counter memory 54 reaches the number of slots S(i). If the number of slots B does not reach the number of slots S(i), the control unit 14 sends a slot start signal nS to the transmission/reception processor 12, as ST62. Then, the control unit returns to the operation of ST56.

When the number of slots B reaches the number of slots S(i) in ST61, the control unit 14 resets the counter memory 54 to “0”, as ST63. Then, the control unit checks the fixed mode flag F of the flag memory 55, as ST64.

When the fixed mode flag F has been reset to “0” in ST64, the control unit 14 judges whether the value {E[ts]−Tr} obtained by subtracting the number of successfully-read slots Tr from the initial estimated number E[ts] becomes less than the switching set value K (an unread response device judging means), as ST65.

When the value {E[ts]−Tr} is not less than the switching set value K, the control unit 14 goes to the operation of ST52, and obtains again the integer value T1(i) satisfying the formula ▾T1(i−1)<E[ts]−Tr≦T1(i)┘. Namely, obtain the minimum integer value T1(i) that is the integer value T1(i){i=1, 2, . . . , n} not less than the value obtained by subtracting the number of RFIDs from which the identification information has been read, from the number of RFIDs in a collective reading unit. Then, the control unit searches the correlation data memory 15, obtains the number of slots S(i) stored corresponding to that integer number value Ti(i), and sends the transmission/reception processor 12 a cycle start signal for assigning this number of slots S(i) (a variable mode control means).

When the value {E[ts]−Tr} is judged less than the switching set value K in ST65, the control unit 14 sets the fixed mode flag F to “1”, as ST66. Namely, the control unit shifts to the fixed mode.

The control unit 14 searches the fixed mode correlation data memory 51, and obtains an integer value T2(i) satisfying the formula ┌T2(i−1)<E[ts]−Tr+α≦T2(i)┘, as ST67. Namely, the minimum integer value T2(i) that is the integer value T2(i){i=1, 2, . . . , n} not less than the value obtained by adding the parameter α to the value obtained by subtracting the number of successfully-read slots Tr up to that time, is obtained from the number of RFIDs in a collective reading unit.

The control unit 14 searches the fixed mode correlation data memory 51, and reads the number of slots S(i) stored corresponding to that integer value T2(i), as ST68. Then, the control unit goes to the operation of ST54, and sends the transmission/reception processor 12 a cycle start signal start for assigning the number of slots S(i) (a fixed mode control means).

When the fixed mode flag F has been set to “1” in ST64, the control unit 14 goes to the operation of ST54 without performing the operations one and after ST65.

Namely, the control unit continuously sends the number of slots S(i) at that time, that is, the cycle start signal for assigning the number of slots S(i) selected immediately after shifting to the fixed mode, to the transmission/reception processor 12.

When the first trigger switch 41 is not turned ON in ST59, the operation proceeds to ST60. When the number of read judgment A reaches the product β·S(i) in ST60, the control unit 14 finishes the reading operation of that time. Namely, the control unit 14 finishes the reading operation when a successfully-read slot is not detected continuously for the times more than the 0 times of the number of slots selected immediately after shifting to the fixed mode.

Assume that a scanner can supply power for a maximum of 35 numbers of RFIDs existing in the communication area 3 of the antenna 2 in one time. Assume that the initial estimated number E[ts] of RFIDs existing in the communication area of the antenna 2 is 25.

At the time of starting the reading operation, in the scanner, the integer value T1(i) satisfying the formula ┌T1(i−1)<E[ts]−Tr≦T1(i)┘ is obtained when I=5, and S(5)=32 can be obtained from the correlation data memory 15 as the number of slots S(i). And, a cycle start signal specifying the number of slots “32” is sent from the antenna 2.

In this case, the number of slots B of the counter memory 54 does not reach the number of slots S(i) until the end of the 32 slots, and a slot start signal nS is sent from the antenna 2 whenever each slot ends.

After the end of the 32 slots, it is judged that the value {E[ts]−Tr} obtained by subtracting the number of successively-read slots Tr from the initial estimated value E[ts] is less than the switching set value K.

Explanation will now be given on a method of determining the parameter α. As described before, assuming a maximum number of RFIDs powered by the scanner in one time to be 35, and an initial estimated number of RFIDs E[ts] as 25, using “25” to “35” as the number of RFIDs in a collective reading unit may be considered to prevent failure in reading a RFID. Therefore, the parameter α is to be set to “5” that is obtained by subtracting the initial estimated number “25” from the intermediate value “30” between “25” and “35”. Namely, the parameter α can be obtained by (upper limit number−initial estimated number E[ts])/2.

Now, assume the switching set value K to be “5” (=25×0.2). In this case, when the number of successfully-read slots Tr is not larger than 20, the value {E[ts]−Tr} is larger than the switching set value K. Therefore, the scanner obtains again the integer value T1(i) satisfying the formula ┌T1(i−1)<E[ts]−Tr≦T1(i)┘. The correlation data memory 15 is then searched, and the number of slots S(i) stored corresponding to that integer value T1(i) is obtained.

For example, when the number of successfully-read slots Tr becomes “10”, the value {E[ts]−Tr} becomes “15” (>K), and the integer value T1(i) is obtained when i=4. Therefore, the number of slots S(4)=16 is obtained from the correlation data memory 15, and the cycle start signal start specifying the number of slots “16” is sent from the antenna 2.

Likewise, when the number of successfully-read slots Tr becomes “15”, the value {E[ts]−Tr} becomes “10” (>K), and the integer value T1(i) is obtained when i=3. Therefore, the number of slots S(3)=8 is obtained from the correlation data memory 15, and the cycle start signal start specifying the number of slots “8” is sent from the antenna 2.

When the number of successfully-read slots Tr becomes “20”, the value {E[ts]−Tr} becomes “5” less than the switching set value K. Then, the fixed mode flag F is set to “1”. In this case, the integer value T2(i) satisfying the formula ┌T2(i−1)<E[ts]−Tr+α≦T2(i)┘ is calculated, and the number of slots S(i) stored corresponding to this integer value T2(i) is determined. As the value of E[ts]−Tr+α is “10”, the integer value T2(2)=10 when i=2 is calculated, by referring to the fixed mode correlation data memory 51 shown in FIG. 20. Therefore, the number of slots S(2)=4 is obtained. And, a cycle start signal start specifying the number of slots “4” is sent from the antenna 2.

Thereafter, as the fixed mode flag F has been set to “1”, whenever four slots are successively received, a cycle start signal start specifying the number of slots “4” is sent from the antenna 2.

When the number of end-of-reading judgment A of the counter memory 53 reaches the product β·S(i), the reading operation of that time is finished. For example, assuming β to be “2”, as the number of slots S(i) is “4”, when a signal concerning a successfully-read slot is not received continuously 8 times, the scanner regards the collective reading of RFIDs existing in the communication area 3 of the antenna 2 as finished.

As described above, the radio communication apparatus 1 stores in the correlation data memory 15 the data indicating the correlation between the number of unread response devices and the number of slots with which the probability that the number of unread response devices to send identification information by including the information in one slot is 1 becomes highest, when that number of unread response devices exists in the communication area 3 of the antenna 2.

The radio communication apparatus 1 judges whether the number of unread response devices at that time is less than a set value (a judging means), before sending a signal to assign a predetermined number of slots to each response device 4. When the number of unread response devices is judged larger than the set value, the radio communication apparatus reads the number of slots corresponding to the number of unread response devices at that time from the correlation data memory 15, and controls to send a signal to assign this number of slots (a variable mode control means).

When the number of unread response devices is judged less than the set value, the radio communication apparatus controls to send a signal to assign a predetermined number of slots.

Concretely, the radio communication apparatus 1 stores in the fixed mode correlation data memory 51 the data indicating the correlation between the number of unread response devices, with which the required number of slots necessary for reading the identification information of all unread answer units when the number of slots assigned to the answer unit 4 is fixed to a first number of slot becomes equal to the required number of slots necessary for the identification information of all unread answer units when the number of slots assigned to the answer unit 4 is fixed to a second number of slots, which is the next larger value of the first number of slots, and the number of first slots.

The radio communication apparatus 1 searches the fixed mode correlation data memory 51 by the number of unread response devices at the time when the number of unread response devices is judged not larger than a set value, reads the number of slots corresponding to that number of unread response devices, and controls to send a signal to assign this number of slots (a fixed mode control means).

Therefore, with such a radio communication apparatus 1, when the number of unread response devices becomes less than the switching set value K, thereafter the number of slots assigned to each response device 4 is fixed. The number of assigned slots just before the end of the reading operation is a little larger than the number of unread response devices, and it is possible to prevent failure in reading identification information.

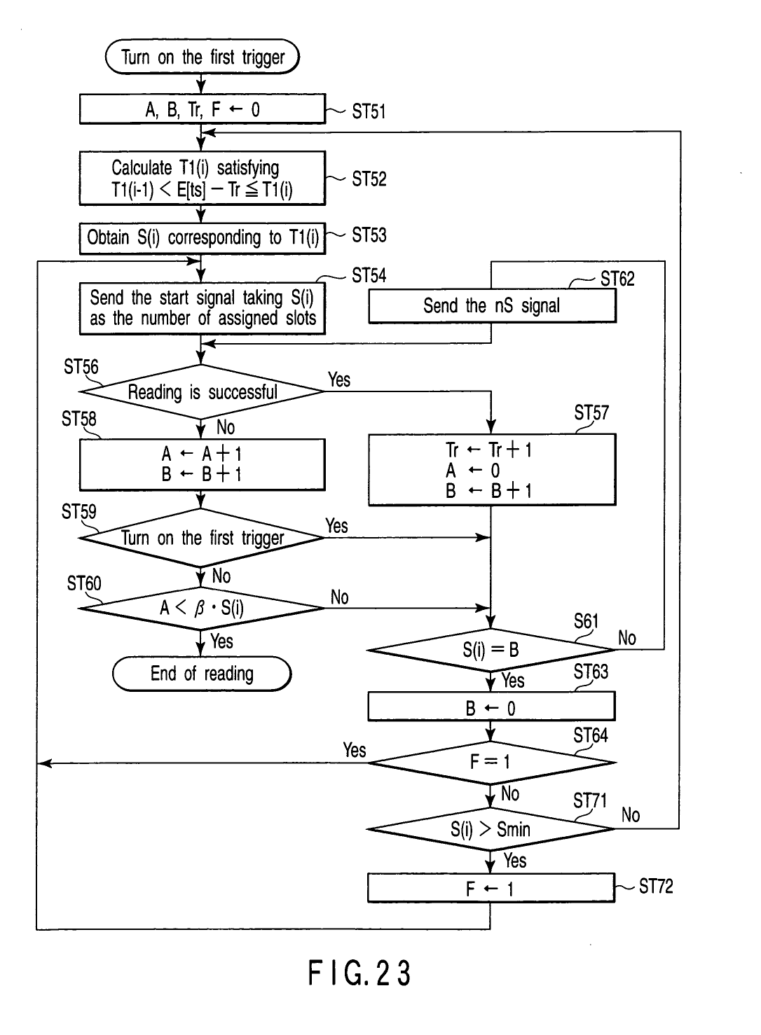

The first deciding procedure is not limited to the procedure shown in FIG. 22. Another example of the first deciding procedure will be explained with reference to the flowchart of FIG. 23, in which the operation flow of the first decision procedure control means is illustrated. This example adopts a system that the last number of slots S(i) in a variable mode is set to the same as the last number of slots S(i) in a fixed mode.

The following formula (29) shows the condition that the last number of slots S(i) in a variable mode becomes the same as the last number of slots S(i) in a fixed mode.
T2(i−1)−T1(i−1)<α≦T2(i)−T1(i) (29)

Assume the number of slots S(i) corresponding to an integer value T2(i) satisfying this formula (29) to be a minimum value of the number of slots reduced as the identification information reading operation advances (hereinafter, called a minimum number of slots S min). For example, assuming the parameter α to be “5” as described before and referring to the correlation data memory 15 and the fixed mode correlation data memory 51, when i=2, that is, S(2)=4 is the minimum number of slots S min.

When the ON signal of the first trigger switch 41 is input to the control unit 14, the control unit 14 starts the reading operation shown in the flowchart of FIG. 23. In FIG. 23, the operations of steps ST51-ST64 are the same as those of the same steps of the procedure shown in FIG. 22, and explanation on these steps will be omitted.

When the fixed mode flag F has been reset to “0” in ST64, the control unit 14 judges whether the number of slots S(i) at the present time is larger than the previously set minimum number of slots S min (a slot number judging means), as ST71. When the number of slots S(i) is larger than the minimum number of slots S min, the control unit 14 goes to the operation of ST52, and obtains again the integer value T1(i) satisfying the formula ┌T1(i−1)<E[ts]−Tr≦T1(i)┘. Then, the control unit searches the correlation data memory 15, and obtains the number of slots S(i) stored corresponding to that integer value T1(i). The control unit sends the transmission/reception processor 12 a cycle start signal start for assigning this number of slots S(i) (a variable mode control means).

Contrarily, when the number of slots S(i) is not larger than the minimum number of slots S min, the control unit 14 sets the fixed mode flag F of the flag memory 55 to “1”, and moves to the fixed mode, as ST72. Then, the control unit goes to the operation of ST54, and sends the transmission/reception processor 12 a cycle start signal start taking the number of slots S(i) at the present time, namely the last number of slots S(i) in the variable mode, as the number of assigned slots (a fixed mode control means).

As described above, the radio communication apparatus 1 judges whether the number of slots assigned by a preceding signal is not larger than the preset minimum number of slots (a slot number judging means), before sending a signal to assign a predetermined number of slots to each response device 4. When the number of slots assigned by the preceding signal is judged larger than the minimum number of slots, the radio communication apparatus reads the number of slots corresponding to the number of unread response devices at that time from the correlation data memory 15, and controls to send a signal to assign this number of slots (a variable mode control means). Contrarily, when the number of slots assigned by the preceding signal is judged not larger than the minimum number of slots, thereafter the radio communication apparatus controls to send a signal to assign a certain number of slots (a fixed mode control means).

Therefore, in this system, the number of assigned slots just before the end of the reading operation is a little larger than the number of unread response devices, and it is possible to prevent failure in reading identification information.

Further, in this system, the last number of slots S(i) in the variable mode is the same value as the last number of slots S(i) in the fixed mode, and the fixed mode correlation data memory 51 can be eliminated as an unnecessary part. Therefore, as appreciated by comparing FIG. 22 and FIG. 23, operation steps corresponding to ST67 and ST68 in FIG. 2 are omitted, and the storage capacity can be saved and the operation can be simplified.

In this system, it is also possible to omit a fixed mode flag F. In this case, the operations of ST64 and ST72 in FIG. 23 can be omitted.

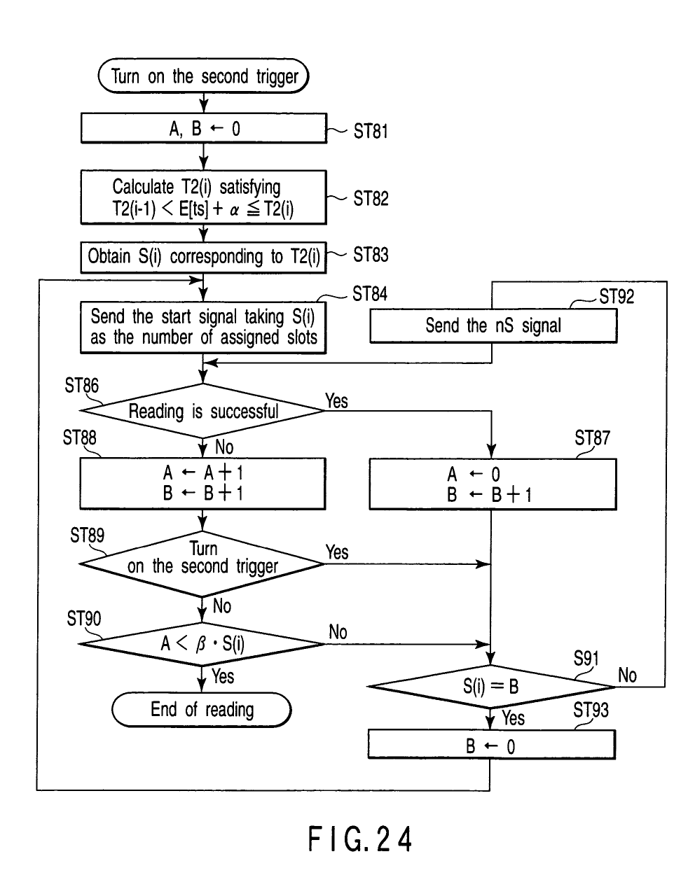

Next, the second deciding procedure will be explained with reference to the flowchart of FIG. 24, in which the control flow of the second decision procedure control means is illustrated.

When the ON signal of the second trigger switch 42 is input to the control unit 14, the control unit 14 starts the reading operation shown in the flowchart of FIG. 24. As a memory area used for executing this operation, the counter memory 53 of the number of end-of-reading judgment A and the counter memory 54 of the number of slots B are formed in the storage unit 13.

The control unit 14 clears the counter memories 53 and 54, as ST81. Then, the control unit obtains an integer value T2(i) satisfying the formula ┌T2(i−1)<E[ts]+α≦T2(i)┘, as ST82. Then, the control unit searches the fixed mode correlation data memory (a second correlation data memory) 51, and obtains the number of slots S(i) stored corresponding to that integer number value T2(i), as ST83. Thereafter, the control unit sends the transmission/reception processor 12a a cycle start signal for assigning this number of slots S(i). In this case, the memory that stores the corresponding data memory 15 shown in FIG. 5 serves as a first correlation data memory.

The control unit 14 judges whether the slot is a successfully-read slot, as ST86.

When the received signal is a successfully-read slot, the control unit 14 counts up the number of slots B of the counter memory 54′ by “1”, as ST87. The control unit resets the number of end-of-reading judgment A of the counter memory 53 to “0”. Thereafter, the control unit goes to the operation of ST91.

If the received signal is not a successfully-read slot in ST86, the control unit 14 counts up the number of end-of-reading judgment A of the counter memory 53 and the number of slots B of the counter memory 54, by “1”, as ST88. Then, the control unit judges whether the input of the ON signal of the second trigger switch 42 is continued, as ST89. When the input of the ON signal is continued, the control unit goes to the operation of ST91.

If the ON signal of the second trigger switch 42 is not input in ST89, the control unit 14 judges whether the number of end-of-reading judgment A reaches the product β·S(i) obtained by multiplying the number of slots S(i) by the coefficient β, as ST90. If the number of the end-of-reading judgment A does not reach the product β·S(i), the control unit goes to the operation of ST91.

In ST91, the control unit 14 judges whether the number of slots B of the counter memory 54 reaches the number of slots S(i). If the number of slots B does not reach the number of slots S(i), the control unit 14 sends a slot start signal nS to the transmission/reception processor 12, as ST92. Then, the control unit returns to the operation of ST86.

When the number of slots B reaches the number of slots S(i) in ST91, the control unit 14 resets the counter memory 54 to “0”, as ST93. Then, the control unit 14 goes to the operation of ST84, and repeatedly sends to the transmission/reception processor 12 a cycle start signal for assigning the number of slots S(i) at the present time (a fixed mode control means).

When the number of end-of-reading judgment A reaches the product β·S(i) in ST90, the control unit 14 finishes the reading operation of that time.

Assume that a scanner can supply power for a maximum of 24 numbers of RFIDs existing in the communication area 3 of the antenna 2 in one time. Assume that the initial estimated number E[ts] of RFIDs existing in the communication area of the antenna 2 is 10.

In this case, as (upper limit value−initial estimated number E[ts])/2, the parameter α is (24−10)/2=7. Therefore, the integer value T1(i) satisfying the formula ┌T2(i−1)<E[ts]+α≦T2(i)┘ is obtained when i=3, by referring to the fixed mode correlation data memory 51 shown in FIG. 20, and the number of time slots S(3)=8 can be obtained in the scanner. And, a cycle start signal specifying the number of slots “8” is sent from the antenna 2. Thereafter, the number of slots is fixed to “8” irrespectively of the increase in the number of successfully-read slots Tr.

As described above, when the second trigger switch 42 is turned on, the number of slots S(i) is fixed to the number set when the reading is started.

In the operation of ST82 in FIG. 24, T2(i) satisfying the following formula (30) is obtained.
T2(i−1)<E[ts]+α≦T2(i) (30)

T2(i) satisfying the formula (29) instead of the formula (30) may be calculated, and the number of slots S(i) stored corresponding to the value of T2(i) may be taken as the number of slots in the fixed mode.

Next, a method of using a scanner will be explained. First, the initial estimated value E[ts] and the values of parameter α and parameter β are sent to the control unit 14 through the data input/output unit 11. The control unit 14 calculates a first number of slots S(i) and a minimum number of slots S min from the correlation between the sent data and S(i)/T1(i) and S(i)/T2(i) previously stored in the correlation data memory 15 and fixed mode correlation data memory 51. And, the control unit stores these calculated values and the values of E[ts] and β in the storage unit 13.

When reading a RFID by such a scanner, the operator estimates the number of RFIDs in a collective reading unit that is to be a reading object by eye measurement, and inputs one of the first trigger switch 41 and second trigger switch 42. For example, the first trigger switch 41 is operated when the number of RFIDs is relatively large, and the second trigger switch 42 is operated when the number of RFIDs is small.

In the radio communication apparatus 1 according to the fifth embodiment, when the first trigger switch 41 is operated and a first reading start trigger signal is input, a first deciding procedure control means is operated.

Namely, the radio communication apparatus 1 judges whether the number of slots assigned by a preceding signal is not larger than a preset minimum number of slots, before sending each response device 4a a signal for assigning a predetermined number of slots. When the number of slots assigned by the preceding signal is judged larger than the minimum number of slots, the radio communication apparatus 1 reads the number of slots corresponding to the number of unread response devices at that time from the correlation data memory 15, and sends a signal for assigning this number of slots. When the number of slots assigned by the preceding number is judged not larger than the minimum number of slots, thereafter the radio communication apparatus sends a signal for assigning a certain number of slots. The certain number is the number set in the fixed mode correlation data memory 51 corresponding to the number of unread response devices at the time when the number of slots is judged less than the minimum number of slots.

On the other hand, when the second trigger switch 42 is operated and a second reading start trigger signal is input, a second deciding procedure control means is operated.

Namely, the radio communication apparatus reads the number of slots corresponding to the number of unread response devices at the time when the second reading start trigger signal is input from the fixed mode correlation data memory 51, and sends a signal for assigning this number of slots.

Therefore, when the first trigger switch 41 is operated, the number of assigned slots is adjusted until the number equals the minimum number of slots S min stored in the storage unit 14, by comparing the correlation among the values E[ts]−Tr, S(i) and T1(i), and the reading operation is executed until a standard for judging the end of operation is satisfied.

When the second trigger switch 42 is operated, the number of assigned slots is fixed to the first number of slots S(i) stored in the storage unit 13, and the reading operation is executed until the standard for judging the end of operation is satisfied.

Therefore, an optimum procedure of determining the number of slots according to the number of response devices 4 can be easily selected.

In the fifth embodiment, the end judging operation is performed only when the trigger switch 41 or 42 is turned off. Namely, the end judging operation is not performed while the trigger switch 41 or 42 is held pressed by the operator (the ON state is held). This prevents the scanner from finishing the reading operation immediately when the radio wave output direction of the scanner is deflected from the position of a RFID, as the radio wave output from the scanner to the RFID is not visible to the operator.

The scanner may be configured so that another reading operation different from the two kinds of reading operations described above is carried out when the trigger switches 41 and 42 are simultaneously pressed.

In the fifth embodiment, the data of the correlation data memory 15 and fixed mode correlation data memory 51 are previously stored in the storage unit 13, but this is not restrictive.

For example, the control unit 14 may be configured to calculate the data of the correlation data memory 15 and fixed mode correlation data memory 51, and store the calculated data in the storage unit 13, by inputting the initial estimated value E[ts], parameters α and β, S(i) and corresponding T1(i) and T2(i) to the control unit 14.

In the fifth embodiment, the minimum number of slots S min of the scanner is determined by the formula (29), but the S min may be determined by the following formula (31).
t2(i−1)−t1(i−1)<α≦t2(i)−t1(i) (31)

In the fifth embodiment, the minimum number of slots S min is adjusted by setting the value of the parameter α in order to avoid a decrease of the reading efficiency caused by frequent occurrence of a collision slot generated just before the end of the reading operation. However, when the number of slots is fixed to the value set when the reading operation is started, the rate of occurrence of a collision slot is small compared with a case that the number of slots is variable. Therefore, when the number of slots is always fixed, a value of the parameter α may be set smaller, or zero.

For example, in the fifth embodiment, the parameter α is set to “7”, but the number of slots when the reading operation is started may be determined by setting the parameter α to “0” and substituting it into the formula (30). In this case, if E[ts]=10, the number of slots assigned when the reading operation is started becomes S(2)=4 by referring to the fixed mode correlation data memory 51.

According to the present embodiment, the radio communication apparatus comprises: a sending means for sending a signal for assigning a predetermined number of slots from an antenna to one or more response devices; a reading means for reading identification information of one or more response devices among response devices receiving the signal, by using a radio communication system in which an response device whose identification information is not yet read, a so-called unread response device individually selects one slot, and transmits own specific identification information in that slot; a correlation data memory which stores data indicating a correlation between the number of unread response devices and the number of slots with which the probability that one unread response device sends the identification information in one slot becomes highest, when said number of unread response devices exist in the communication area of the antenna; an assigned slot number judging means for judging whether the number of slots assigned in accordance with the signal immediately preceding the to-be-sent signal is equal to or less than the previously set minimum number of slots; a retrieving means for searching the correlation data memory by the number of unread response devices calculated then and acquiring the number of slots corresponding to the calculated number of unread response devices, when the number of slots assigned in accordance with the signal immediately preceding the to-be-sent signal is greater than the previously set minimum number of slots; a variable mode control means for controlling the antenna to send a signal used for assigning slots in the number which the retrieving means acquires from the memory; and a fixed mode control means for controlling the antenna to send a signal used for assigning a constant number of slots, when the number of slots which the assigned slot number judging means assigns in accordance with the signal immediately preceding the to-be-sent signal is equal to or less than the previously set minimum number of slots. Owing to these features, the storage capacity can be saved, and the processing time can be short.

According to the present embodiment, furthermore, the radio communication apparatus comprises: a sending means for sending a signal for assigning a predetermined number of slots from an antenna to one or more response devices; a reading means for reading identification information of one or more response devices among response devices receiving the signal, by using a radio communication system in which an response device whose identification information is not yet read, a so-called unread response device individually selects one slot, and transmits own specific identification information in that slot; a first correlation data memory which stores data indicating a correlation between the number of unread response devices and the number of slots with which the probability that one unread response device sends the identification information in one slot becomes highest, when said number of unread response devices exist in the communication area of the antenna; a second correlation data memory which stores a correlation between the number of unread response devices and a first number of slots, when the number of slots necessary for reading identification information of all unread response devices when the number of slots assigned to the response devices is fixed to a first number of slots, and the number of slots necessary for reading identification information of all unread response devices when the number of slots assigned to the response devices is fixed to a second number of slots large next to the first number of slots, become equal to each other; a first trigger signal generating means for generating a first read-start trigger signal; a second trigger signal generating means for generating a second read-start trigger signal; a first decision procedure control means, responsive to input of the first read-start trigger signal generated by the first trigger signal generating means, for (i) judging whether the number of slots assigned in accordance with the signal immediately preceding the to-be-sent signal is equal to or less than the previously set minimum number of slots, (ii) for searching the first correlation data memory by the number of unread response devices calculated then, acquiring the number of slots corresponding to the calculated number of unread response devices, and controlling the antenna to send a signal used for assigning slots in the acquired number, when the number of slots assigned in accordance with the signal immediately preceding the to-be-sent signal is greater than the previously set minimum number of slots, and (iii) for controlling the antenna to send a signal used for assigning a constant number of slots, when the number of slots assigned in accordance with the signal immediately preceding the to-be-sent signal is equal to or less than the minimum is number of slots; and a second decision procedure control means, responsive to input of the second read-start trigger signal generated by the second trigger signal generating means, for searching the second correlation data memory by the number of unread response devices at the time when the second read-start trigger signal is input, acquiring the first slot number corresponding to the number of unread response devices, and controlling the antenna to repeatedly send a signal used for assigning the acquired number of slots. Owing to this feature, the first decision procedure control means is used for processing when the number of response devices is greater than a predetermined number, and the second decision procedure is used for processing when the number of response devices is smaller than the predetermined number. By so doing, it is possible to acquire the number of slots that enables efficient answers. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication apparatus comprising:
a sending means for sending a signal for assigning
a predetermined number of slots from an antenna to one or more response devices;
a reading means for reading identification information of one or more response devices among response devices receiving the signal, by using a radio communication system in which an response device whose identification information is not yet read, a so-called unread response device, individually selects one slot, and transmits own specific identification information in that slot;
an all slot number counter for counting the number of all slots that are within a slot counting period in a predetermined period after the signal is sent;
an empty slot number counter for counting the number of empty slots whose identification information is not transmitted by an response device, among all slots that are within the slot counting period;
an estimated number calculation means for calculating an estimated number of the unread response devices based on the counted values of the all slot number counter and empty slot number counter, and the number of slots assigned by the signal, at the time when the predetermined period has passed; and
a deciding means for deciding the number of slots assigned by the signal to be sent next, based on the estimated number of unread response devices.

2. The radio communication apparatus according to claim 1, further comprising:
a correlation data memory which stores data indicating a correlation between the number of unread response devices and the number of slots with which the probability that one unread response device sends the identification information in one slot becomes highest, when said number of unread response devices exist in the communication area of the antenna; and
a retrieving means for searching the correlation data memory by an estimated number of unread response devices calculated by the estimated number calculation means, and reading the number of slots corresponding to the estimated number from the correlation data memory,
wherein the number of slots to be stored in the correlation data memory is within a range of the number of slots assignable by the signal, and
the sending means sends a signal for assigning the number of slots read from the correlation data memory.

3. The radio communication apparatus according to claim 1, further comprising:
a successfully-read slot number counter for counting the number of successfully-read slots for which only one response device transmits identification information, among all slots that are within the slot counting period; and
an estimated number updating means for updating the estimated number of unread response devices calculated by the estimated number calculation means, to a number obtained by subtracting a value counted by the successfully-read slot number counter,
wherein the deciding means decides the number of slots assigned by the signal to be sent next, based on the estimated number of unread response devices updated by the estimated number updating means.

4. The radio communication apparatus according to claim 2, wherein the correlation data memory stores the number of unread response devices for each kind of assignable slot number, when the probability becomes equal with said number of slots and the number of slots that is the next larger value of said number of slots, and
the retrieving means searches the correlation data memory by the estimated number of unread response devices at the time before the signal is sent, detects the minimum number of unread response devices not less than the estimated number, and reads the number of slots corresponding to the number of unread response devices from the correlation data memory.

5. A radio communication apparatus comprising:
a sending means for sending a signal for assigning
a predetermined number of slots from an antenna to one or more response devices;
a reading means for reading identification information of one or more response devices among response devices receiving the signal, by using a radio communication system in which an response device whose identification information is not yet read, a so-called unread response device, individually selects one slot, and transmits own specific identification information in that slot;
a successfully-read slot number counter for counting the number of successfully-read slots for which only one response device transmits identification information, among slots that are within a slot counting period in a predetermined period after the signal is sent;
an expected value calculation means for calculating an expected value when the number of response devices existing in the communication area of the antenna is more than the calculated value of the successfully-read slot number counter;
an estimated number calculation means for calculating an estimated number of the unread response devices at the time when the predetermined period has passed, as a value obtained by subtracting the counted value of the successfully-read slot number counter from the expected value; and
a deciding means for deciding the number of slots assigned by the signal to be sent next, based on the estimated number of unread response devices.

6. The radio communication apparatus according to claim 5, wherein the expected value calculation means calculates the expected value by multiplying the number of response devices existing in the communication area of the antenna by a value of a probability density function not less than the counted value of the successfully-read slot number counter, and by integrating the product from the counted value of the successfully-read slot number counter to an infinity value, with respect to the number of response devices.

7. The radio communication apparatus according to claim 5, wherein the expected value calculation means takes a median of a probability density function in which the number of response devices existing in the communication area of the antenna becomes not less than the counted value of the successfully-read slot number counter, as the expected value.

8. The radio communication apparatus according to claim 5, further comprising:
a correlation data memory which stores data indicating a correlation between the number of successfully-read slots and the number of slots with which the probability that one unread response device sends the identification information in one slot becomes highest, when the estimated number of unread response devices calculated by the estimated number calculation means exists in the communication area of the antenna; and
a retrieving means for searching the correlation data memory by the counted value of the successfully-read slot number counter, and reading the number of slots corresponding to the counted value from the correlation data memory,
wherein the number of slots to store the correlation data memory is within a range of the number of slots assignable by the signal, and
the sending means sends a signal for assigning the number of slots read from the correlation data memory.

9. A radio communication apparatus comprising:
a sending means for sending a signal for assigning
a predetermined number of slots from an antenna to one or more response devices;
a reading means for reading identification information of one or more response devices among response devices receiving the signal, by using a radio communication system in which an response device whose identification information is not yet read, a so-called unread response device individually selects one slot, and transmits own specific identification information in that slot;
a correlation data memory which stores data indicating a correlation between the number of unread response devices and the number of slots with which the probability that one unread response device sends the identification information in one slot becomes highest, when said number of unread response devices exist in the communication area of the antenna; and
a retrieving means for searching the correlation data memory by an actual number of the unread response devices at the time before the signal is sent, and reading the number of slots corresponding to the actual number from the correlation data memory,
wherein the number of slots to store the correlation data memory is within the range of the number of slots assignable by the signal, and
the sending means sends a signal for assigning the number of slots read from the correlation data memory.

10. The radio communication apparatus according to claim 9, wherein the correlation data memory stores the number of unread response devices for each kind of assignable slot number when the probability becomes equal with said number of slots and the number of slots that is the next larger value of said number of slots, and
the retrieving means searches the correlation data memory by the actual number of unread response devices at the time before the signal is sent, detects a minimum number of unread response devices larger than the actual number, and reads the number of slots corresponding to the number of unread response devices from the correlation data memory.

11. The radio communication apparatus according to claim 9, further comprising:
an actual number memory for storing the actual number of unread response devices at the time before the signal is sent;
a successfully-read slot number counter for counting the number of successfully-read slots for which only one response device sends identification information, among slots received within a slot counting period in a predetermined period after the signal is sent; and
an actual number updating means for updating the actual number by subtracting the counted value of the successfully-read slot number counter from the actual number stored in the actual number memory,
wherein the retrieving means searches the correlation data memory by the actual number of unread response devices stored in the actual number memory, and reads the number of slots corresponding to the actual number from the correlation data memory.

12. A radio communication apparatus comprising:
a sending means for sending a signal for assigning
a predetermined number of slots from an antenna to one or more response devices;
a reading means for reading identification information of one or more response devices among response devices receiving the signal, by using a radio communication system in which an response device whose identification information is not yet read, a so-called unread response device individually selects one slot, and transmits own specific identification information in that slot;
a correlation data memory which stores data indicating a correlation between the number of unread response devices and the number of slots with which the probability that one unread response device sends the identification information in one slot becomes highest, when said number of unread response devices exist in the communication area of the antenna;
a judging means for judging whether the number of unread response devices at the time before the signal is sent is less than a set value;
a variable mode control means for reading the number corresponding to the number of unread response devices from the correlation data memory at the time when the number of unread response devices is judged larger than the set value, and controlling the sending means to send a signal for assigning the number of slots; and
a fixed mode control means for controlling the sending means to send a signal for assigning a predetermined number of slots, when the number of unread units is judged less than the set value;
wherein the number of slots stored in the correlation data memory is within a range of the number of slots assignable by the signal.

13. The radio communication apparatus according to claim 12, wherein the correlation data memory stores the number of unread response devices for each kind of assignable slot number, when the probability becomes equal with said number of slots and the number of slots large next to said number of slots,
the variable mode control means searches the correlation data memory by the number of unread response devices at the time before the signal is sent, detects a minimum stored value of unread response devices larger than that number, reads the number of slots corresponding to the stored value of unread response devices from the correlation data memory, and controls the sending means to send a signal for assigning the number of slots.

14. The radio communication apparatus according to claim 12, further comprising:
a fixed mode correlation data memory which stores a correlation between the number of unread response devices and a first number of slots, when the number of slots necessary for reading identification information of all unread response devices when the number of slots assigned to the response devices is fixed to a first number of slots, and the number of slots necessary for reading identification information of all unread response devices when the number of slots assigned to the response devices is fixed to a second number of slots that is the next larger value of the first number of slots, becomes equal,
wherein the number of slots stored in the fixed mode correlation data memory is within a range of the number of slots assignable by the signal, and
the fixed mode control means retrieves the fixed mode correlation data memory by the number of unread response devices at the time when the number of unread response devices is judged not large than the set value, reads the number of slots corresponding to the number of unread response devices, and controls the sending means to send a signal for assigning the number of slots.

15. A radio communication apparatus comprising:
a sending means for sending a signal for assigning
a predetermined number of slots from an antenna to one or more response devices;
a reading means for reading identification information of one or more response devices among response devices receiving the signal, by using a radio communication system in which an response device whose identification information is not yet read, a so-called unread response device individually selects one slot, and transmits own specific identification information in that slot;
a fixed mode correlation data memory which stores a correlation between the number of unread response devices and a first number of slots, when the number of slots necessary for reading identification information of all unread response devices when the number of slots assigned to the response devices is fixed to a first number of slots, and the number of slots necessary for reading identification information of all unread response devices when the number of slots assigned to the response devices is fixed to a second number of slots large next to the first number of slots, become equal to each other; and
a retrieving means for searching the fixed mode correlation data memory by the number of unread response devices at the time before the signal is sent, and reading the number of slots corresponding to the number of unread response devices from the fixed mode correlation data memory,
wherein the number of slots stored in the fixed mode correlation data memory is within a range of the number of slots assignable by the signal, and
the sending means repeatedly sends a signal for assigning the number of slots read from the correlation data memory.
